(19) United States
(12) Patent Application Publication
(10) Pub. No.: US 2024/0118948 A1
(43) Pub. Date: Apr. 11, 2024

(54) COPY AND PASTE FOR DASHBOARD USER INTERFACES

(71) Applicant: Tableau Software, LLC, Seattle, WA (US)

(72) Inventors: Brian Thomas Carver, Kirkland, WA (US); Brian Scott Rushton, Monroe, WA (US)

(21) Appl. No.: 17/961,213

(22) Filed: Oct. 6, 2022

(51) Int. Cl. G06F 9/54; G06F 3/04842

(52) U.S. Cl. CPC G06F 9/543; G06F 3/04842

(57) ABSTRACT

Embodiments are directed to copy and paste for dashboard user interfaces. A dashboard that displays a plurality of zones and a plurality of user interface objects may be provided. If a user input corresponding to copying one or more zones is provided, user interface objects associated with the one or more zones may be determined based on a dashboard model that may correspond to the dashboard and placed in a container that may be stored in a system clipboard. In response to receiving a second user input corresponding to a paste command: generating new zones and new user interface objects for the target dashboard based on the copied zones and the copied user interface objects. The new zones and the new user interface objects may be integrated into the target dashboard and displayed.

### TECHNICAL FIELD

The present invention relates generally data visualizations, and more particularly, but not exclusively to, copy and paste for dashboard user interfaces.

### BACKGROUND

Organizations are generating and collecting an ever-increasing amount of data. This data may be associated with disparate parts of the organization, such as, consumer activity, manufacturing activity, customer service, network activity logs, and big data. In some cases, the quantity and dissimilarity of data associated with an organization may make it difficult to effectively utilize available data to improve business practices, provide useful business intelligence, or otherwise reason about their data. Accordingly, in some cases, organizations may employ computer-based applications or tools to generate user interfaces, such as, dashboards that may provide one or more visualizations, or the like, to help enable improved reasoning about some or all of their data or business operations.

In some cases, dashboards may include several different visual objects that have been designed to visualize various business information, metrics, key performance indicators, or the like. In some cases, one or more visual objects in a dashboard may be comprised of other sub-visual objects. Also, in some cases, users may spend significant time styling or otherwise customizing the appearance of the visual objects included in a dashboard. Accordingly, it may be advantageous to enable users to reuse visual objects designed for one dashboard in another dashboard. However, sharing or reusing visual objects in different dashboard may be difficult because of the complex interactions of visual objects in dashboard. Thus, it is with respect to these considerations and others that the present innovations have been made.

### BRIEF DESCRIPTION OF THE DRAWINGS

Non-limiting and non-exhaustive embodiments of the present innovations are described with reference to the following drawings. In the drawings, like reference numerals refer to like parts throughout the various figures unless otherwise specified. For a better understanding of the described innovations, reference will be made to the following Detailed Description of Various Embodiments, which is to be read in association with the accompanying drawings, wherein:

FIG. 1 illustrates a logical architecture of a system for copy and paste for dashboard user interfaces in accordance with one or more of the various embodiments;

FIG. 2 illustrates a portion of a user interface that may be considered a dashboard in accordance with one or more of the various embodiments;

FIG. 3 illustrates a logical representation of a zone for copy and paste for dashboard user interfaces in accordance with one or more of the various embodiments;

FIG. 4 illustrates a logical schematic of a data structure for copy and paste for dashboard user interfaces in accordance with one or more of the various embodiments;

FIG. 5 illustrates an overview flowchart for a process for copy and paste for dashboard user interfaces in accordance with one or more of the various embodiments;

FIG. 6 illustrates a flowchart for a process for copy and paste for dashboard user interfaces in accordance with one or more of the various embodiments;

FIG. 7 illustrates a flowchart for a process for copy and paste for dashboard user interfaces in accordance with one or more of the various embodiments;

FIG. 8 illustrates a flowchart for a process for copy and paste for dashboard user interfaces in accordance with one or more of the various embodiments;

FIG. 9 illustrates a flowchart for a process for copy and paste for dashboard user interfaces in accordance with one or more of the various embodiments;

FIG. 10 shows components of one embodiment of an environment in which embodiments of these innovations may be practiced;

FIG. 11 shows one embodiment of a client computer that may include many more or less components than those shown; and

FIG. 12 shows one embodiment of a network computer that may be included in a system implementing one or more of the various embodiments.

### DETAILED DESCRIPTION OF VARIOUS EMBODIMENTS

Various embodiments now will be described more fully hereinafter with reference to the accompanying drawings, which form a part hereof, and which show, by way of illustration, specific exemplary embodiments by which the invention may be practiced. The embodiments may, however, be embodied in many different forms and should not be construed as limited to the embodiments set forth herein; rather, these embodiments are provided so that this disclosure will be thorough and complete, and will fully convey the scope of the embodiments to those skilled in the art. Among other things, the various embodiments may be methods, systems, media or devices. Accordingly, the various embodiments may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments may be readily combined, without departing from the scope or spirit of the invention.

In addition, as used herein, the term “or” is an inclusive “or” operator and is equivalent to the term “and/or,” unless the context clearly dictates otherwise. The term “based on” is not exclusive and allows for being based on additional factors not described unless the context clearly dictates otherwise. In addition, throughout the specification, the meaning of “a,” “an,” and “the” include plural references. The meaning of “in” includes “in” and “on.”

For example, embodiments, the following terms are also used herein according to the corresponding meaning, unless the context clearly dictates otherwise.

As used herein the term, “engine” refers to logic embodied in hardware or software instructions, which can be written in a programming language, such as C, C++, Objective-C, COBOL, Java™, PHP, Perl, JavaScript, Ruby, VB Script, Microsoft .NET™ languages such as C#, or the like. An engine may be compiled into executable programs or written in interpreted programming languages. Software engines may be callable from other engines or from themselves. Engines described herein refer to one or more logical modules that can be merged with other engines or applications or can be divided into sub-engines. The engines can be stored in non-transitory computer-readable medium or computer storage device and be stored on and executed by one or more general purpose computers, thus creating a special purpose computer configured to provide the engine.

As used herein the term “data source” refers to the source of the underlying information that is being modeled or otherwise analyzed. Data sources may include information from or provided by databases (e.g., relational, graph-based, NoSQL, or the like), file systems, unstructured data, streams, or the like. Data sources are typically arranged to model, record, or memorialize various operations or activities associated with an organization. In some cases, data sources are arranged to provide or facilitate various data-focused actions, such as, efficient storage, queries, indexing, data exchange, search, updates, or the like. Generally, a data source may be arranged to provide features related to data manipulation or data management rather than providing an easy-to-understand presentation or visualization of the data.

As used herein the term “data model” refers to one or more data structures that provide a representation of an underlying data source. In some cases, data models may provide views of a data source for particular applications. Data models may be considered views or interfaces to the underlying data source. In some cases, data models may map directly to a data source (e.g., practically a logical pass through). Also, in some cases, data models may be provided by a data source. In some circumstances, data models may be considered interfaces to data sources. Data models enable organizations to organize or present information from data sources in ways that may be more convenient, more meaningful (e.g., easier to reason about), safer, or the like.

As used herein the term “data object” refers to one or more entities or data structures that comprise data models. In some cases, data objects may be considered portions of the data model. Data objects may represent individual instances of items or classes or kinds of items.

As used herein the term “attribute” refers to a named or nameable property or attribute of a data object. In some cases, data fields may be considered analogous to class members of an object in object-oriented programming.

As used herein the term “visualization model” refers to one or more data structures that visualization engines may employ to generate visualizations for display on one or more hardware displays. Visualization models may define various features or objects that visualization engines may render into a displayed visualization including styling or user interface features that may be made available to non-authoring users.

As used herein the term “panel” refers to region within a graphical user interface (GUI) that has a defined geometry (e.g., x, y, z-order) within the GUI. Panels may be arranged to display information to users or to host one or more interactive controls. The geometry or styles associated with panels may be defined using configuration information, including dynamic rules. Also, in some cases, users may be enabled to perform actions on one or more panels, such as, moving, showing, hiding, re-sizing, re-ordering, or the like.

As used herein the term “dashboard” refers to user interfaces that may be specialized for representing dashboard user interfaces. Conventionally, dashboard user interfaces present a collection of related visualizations that enable users to quickly “see” information that may be important to an organization or its operation. The particular visualizations that comprise a given dashboard user interface may varying factors, including subject matter, problem domain, purpose of the dashboard, author intent, Typically, though not always, dashboards may comprise two or more visualizations or user interface controls arranged using tiled layouts, floating layouts, or the like. In some cases, dashboards may be interactive or one or more visualizations in a dashboard may be interactive. Also, in some cases, dashboards may include other user interface features, such as, legends, one or more user interface controls, text annotations, or the like.

As used herein the term “dashboard model” refers to one or more data structures that visualization engines may employ to generate dashboards for display on one or more hardware displays. Dashboard models may declare how one or more visualizations or other objects that may be arranged for display in a corresponding dashboard user interface. Dashboard models may be considered similar to visualization models and may define various features or objects that visualization engines may render into a displayed dashboard including styling or user interface features that may be made available to non-authoring users.

As used herein the term “configuration information” refers to information that may include rule based policies, pattern matching, scripts (e.g., computer readable instructions), or the like, that may be provided from various sources, including, configuration files, databases, user input, built-in defaults, or the like, or combination thereof.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to copy and paste for dashboard user interfaces. In one or more of the various embodiments, a dashboard that displays a plurality of zones and a plurality of user interface objects may be provided such that a first user interface object may be associated with a first zone and a second user interface object may be associated with a second zone.

In one or more of the various embodiments, a first user input corresponding to selection of one or more zones included in the plurality of zones may be received.

In one or more of the various embodiments, in response to receiving a second user input: determining one or more user interface objects associated with the one or more zones based on a dashboard model that may correspond to the dashboard; copying the one or more zones and the one or more user interfaces objects into a container that may be stored in a system clipboard; or the like.

In one or more of the various embodiments, in response to receiving a second user input corresponding to a paste command directed to a target dashboard, further actions may be performed, including: generating one or more new zones and one or more new user interface objects for a target dashboard model that may be associated with the target dashboard based on the one or more copied zones and the one or more copied user interface objects; integrating the one or more new zones and the one or more new user interface objects into the target dashboard model; displaying the one or more new zones and the one or more new user interface objects in the target dashboard based on the target dashboard model; or the like.

In one or more of the various embodiments, generating the one or more new zones and the one or more new user interface objects may include: obtaining the container from the system clipboard; traversing the contents of the container based on another dashboard model that may be included in the container and independent of the dashboard; determining one or more object types associated with the one or more new user interface objects based on the traversal; determining one or more attributes of the one or more new user interface objects based on the traversal; or the like.

In one or more of the various embodiments, generating the one or more new zones and the one or more new user interface objects may include: determining extra data that may be associated with a portion of the one or more copied user interface objects such that the extra data may be one or more of image data, text data, audio data, or the like; obtaining the extra data from the container; including the extra data in the target dashboard model; or the like.

In one or more of the various embodiments, integrating the one or more new zones and the one or more new user interface objects may include: determining one or more object identifiers associated with the one or more copied zones and the one or more copied user interface objects; determining one or more other object identifiers associated with the target dashboard; modifying the one or more object identifiers and the one or more other object identifiers such that the one or more modified object identifiers and the one or more modified other object identifiers conform to a policy associated with the target dashboard.

In one or more of the various embodiments, generating the one or more new zones and the one or more new user interface objects may include: determining a version indicator associated with the one or more copied zones and the one or more copied user interface objects; determining another version indicator associated with the target dashboard; in response to a mismatch of the version indicator and the other version indicator: determining one or more characteristics of the one or more copied zones and the one or more copied user interface objects that correspond to the mismatch; and modifying the one or more characteristics to conform with the other version indicator such that the one or more modified characteristics may be included in the one or more new zones and the one or more new user interface objects.

In one or more of the various embodiments, integrating the one or more new zones and the one or more new user interface objects may include: determining one or more actions associated with the one or more copied user interface objects based on its object type; determining one or more other user interface objects in the target dashboard that are associated with the one or more actions; assigning the one or more actions to the one or more other user interface objects; or the like.

In one or more of the various embodiments, the first user input or the second user input, may include one or more of a pointing device action, a menu selection, or a keystroke.

### Illustrative Logical System Architecture

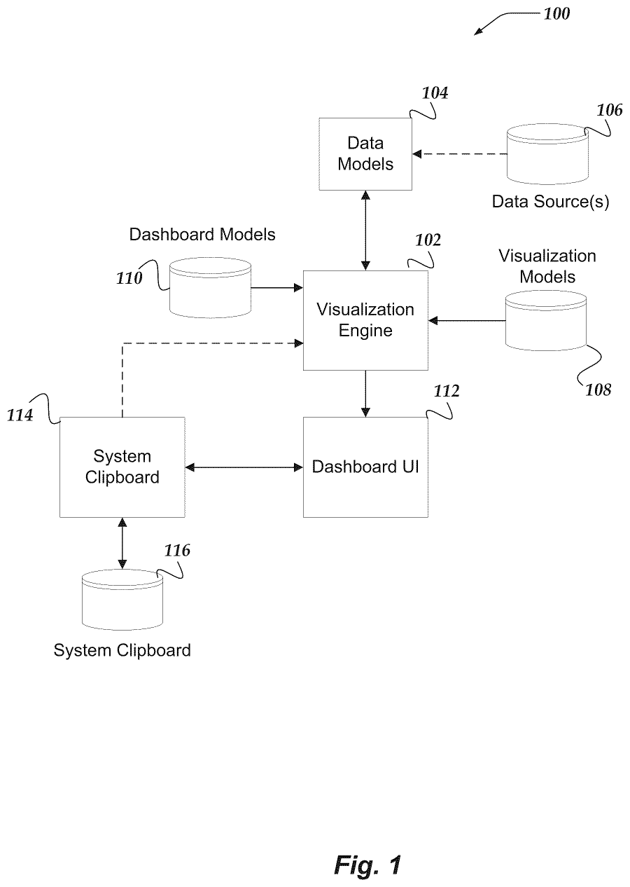

FIG. 1 illustrates a logical architecture of system 100 for copy and paste for dashboard user interfaces in accordance with one or more of the various embodiments. In one or more of the various embodiments, system 100 may be a visualization platform arranged to include various components including, visualization engine 102, data models 104, data source(s) 106, visualization models 108, dashboards 110, dashboard user interface 112, system clipboard 114, system clipboard 116, visualizations 118, or the like.

In one or more of the various embodiments, data sources 106 may represent a source of raw data, records, data items, or the like, that provide the underlying data may be employed for generating visualizations.

In one or more of the various embodiments, data models, such as, data models 104 may be data structures, or the like, that provide one or more logical representations of the information stored in one or more data sources, such as, data source 106. In some embodiments, data models may include data objects that correspond to one or more portions of tables, views, or files in data sources. For example, in some embodiments, if data source 106 is a CSV file or a database, a data model may comprise of one or more data objects that may correspond to record fields in data source 106. Likewise, in some embodiments, data models may include fields or attributes that correspond to fields or attributes in data sources. For example, in some embodiments, if data source 106 is a Relational Database System (RDBMS), a data model included in data models 104 may be comprised of one or more data model fields that correspond to one or more columns or one or more tables included in data sources 106.

In some embodiments, a visualization engine, such as, visualization engine 102 may be employed to transform data from data sources 106 into data models 104. In some embodiments, visualization engines may be arranged to employ or execute computer readable instructions provided by configuration information to determine some or all of the steps for transforming values in data sources into data models. For example, visualization engines may be arranged to provide one or more user interfaces that enable users to author/design data models from data sources.

In one or more of the various embodiments, visualization engines, such as, visualization engine 102 may be arranged to employ visualization models, such as, visualization models 108 to determine the layout, styling, interactivity, or the like, for visualizations that may be displayed to users or included dashboard user interfaces. Also, in some embodiments, visualization engines may be arranged to employ data provided via data sources 106 to populate visualizations with values based on data models.

In one or more of the various embodiments, visualization models may be defined using one or more visualization specifications. In some embodiments, visualization specifications may include computer readable instructions, such as, formal or semi-formal rules that may correspond to one or more portions of visualization models. In some embodiments, visualization specifications may be used to represent or define one or more visualization models. In some embodiments, visualization specifications may be employed to generate visualization models or visualizations.

In some embodiments, dashboard user interfaces, such as, dashboard user interface 112, may be a form of visual analytics that may often be employed in business intelligence applications, informatics, or industrial monitoring as well as many other domains or analytical tasks. In some embodiments, these visual displays may take many forms and styles based on the data acquired and the information needs of the viewer or analyst. In some cases, due to this variety, there may be a lack of consistent, agreed-to definitions for what constitutes a quality dashboard visualization. Accordingly, it may be conventional to adopt a broad view of what can be considered a dashboard including infographics, narrative elements, or the like. Herein, for some embodiments, dashboard user interfaces may be user interfaces arranged to at least include a visual display of important information that may be needed to achieve one or more user intentions or objectives; consolidated and arranged on a single screen so the information may be monitored at a glance.

In some embodiments, computing systems that may be hosting dashboards or dashboard authoring tools may provide so-called system clipboards, such as, system clipboard 114 that enable users or services to transfer data between applications via a shared memory provided by the clipboard system. For example, operating system may provide APIs that enable applications to exchange data that a user has stored (e.g., copied) to a clipboard by providing one or more inputs that indicate the user intends to ‘paste’ the stored objects into another application.

Accordingly, in some embodiments, visualization platforms may be arranged to enable users to utilize system clipboards to copy user interface objects from one dashboard to another. Or, similarly, in some embodiments, system clipboards may enable users to duplicate objects in a dashboard by copying object from the dashboard and pasting them into the same dashboard.

In some embodiments, visualization engines may be arranged to enable users to select one or more user interface zones (e.g., zones) that may include one or more user interface objects such that the selected zones may determine the user interface objects that may be stored in a clipboard. Thus, in some embodiments, users may be enabled to select more than one object at the same time if they are in the same zone.

In one or more of the various embodiments, some user interface objects included in dashboards may associated with various attributes that may require modification or adaptation to enable them to be included another dashboard that may be the target of a paste operation. For example, in some embodiments, identifiers associated with copied objects may require modification to integrate with the object identifiers or identifier policies associated with a target dashboard.

Also, in some embodiments, visualization engines may be arranged to support copying objects from one version of a dashboard authoring tool or visualization platform to another version. Accordingly, in some embodiments, if there may be a version mismatch between the source dashboard and the target dashboard, visualization engines may be arranged to modify incoming objects or zones to conform to one or more requirements or features of the target dashboard.

In one or more of the various embodiments, visualization engines may be arranged to traverse dashboard models to determine one or more features or characteristics or one or more zones or one or more user interface object included in a displayed dashboard user interface. Accordingly, in some embodiments, visualization engines may be arranged to determine one or more relationships between various included zones or objects based on the dashboard model that may correspond to a display dashboard user interface. Thus, in some embodiments, if a user selects a zone in displayed dashboard user interface for copying to a system clipboard, visualization engines may be arranged to traverse a dashboard model that corresponds to the displayed dashboard user interface to determine which user interface objects may need to be copied.

In one or more of the various embodiments, visualization engines may be arranged to generate employ dashboard containers to store one or more zones or one or more user interface objects in system clipboards. In some embodiments, visualization engines may be arranged to automatically generate a dashboard model in dashboard containers (e.g., containers) for representing the zones or objects that may be stored in a system clipboard. Accordingly, in some embodiments, visualization engines may be arranged to traverse the dashboard model associated with a container to determine the one or more zones or one or more user interface objects that are inside.

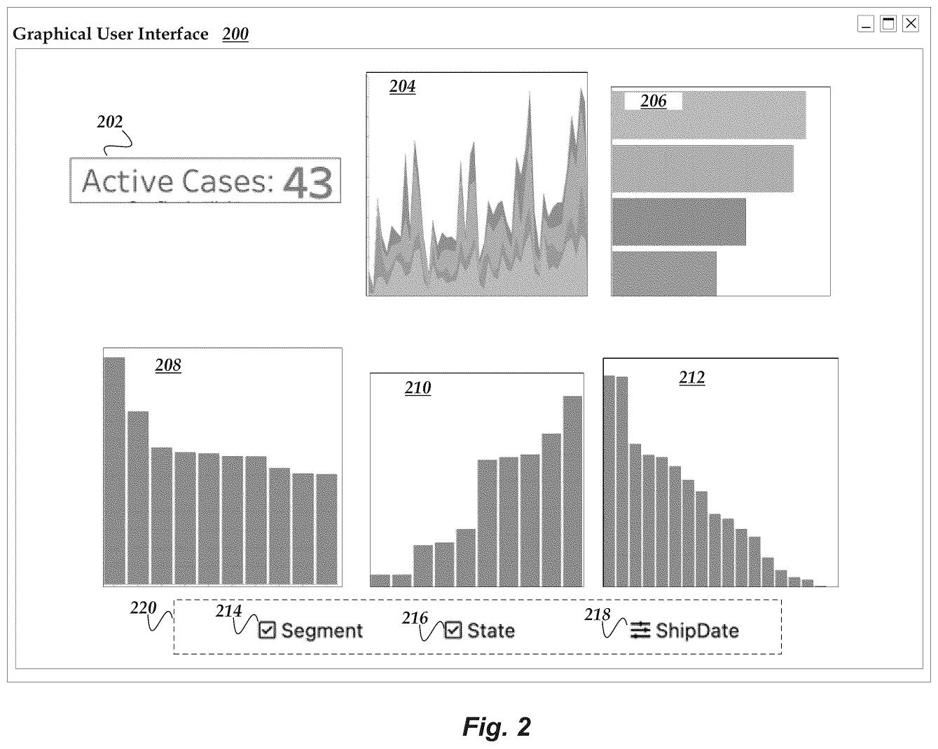

FIG. 2 illustrates a portion of user interface 200 that may be considered a dashboard in accordance with one or more of the various embodiments. In this example, user interface 200 includes several different visualizations that comprise a dashboard, including, visualization 202, visualization 204, visualization 206, visualization 208, visualization 210, visualization 212, or the like. These visualizations may be considered to represent visualizations of various quantities, measures, KPIs, statuses, or the like. Further, in some cases, for some embodiments, dashboards, such as, dashboard 200 may include one or more controls, represented here by control 214, control 216, or control 218.

In one or more of the various embodiments, user interface 200 may be displayed on one or more hardware displays, such as, client computer displays, mobile device displays, or the like. In some embodiments, user interface 200 may be provided via a native application or as a web application hosted in a web browser or other similar applications. One of ordinary skill in the art will appreciate that for at least clarity or brevity many details common to commercial/production user interfaces have been omitted from user interface 200. Likewise, in some embodiments, user interfaces may be arranged differently than shown depending on local circumstances or local requirements, such as, display type, display resolution, user preferences, or the like. However, one of ordinary skill in the art will appreciate that the disclosure/description of user interface 200 is at least sufficient for disclosing the innovations included herein.

In one or more of the various embodiments, one or more items that comprise a dashboard may be grouped or contained in a user interface zone. Accordingly, in this example, zone 220 may be a user interface zone that includes one or more user interface objects, such as, control 214, control 216, control 218, or the like. In some embodiments, user interface zones (e.g., zones) may be data structures that enable one or more user interface objects, user interface controls, visualizations, or the like. to be grouped together. In some embodiments, the border of a zone may be transparent or otherwise hidden from non-authoring users. Alternatively, in some embodiments, zones may be configured to a have a visible border.

In one or more of the various embodiments, visualization engines may be arranged to enable authoring users to select zone using one or more user interface input methods, such as, mouse pointers, touch pointing, keyboard selection, hotkeys, or the like. Accordingly, in some embodiments, if a zone may be selected, visualization engines may be arranged to activate temporary styling features that indicate that the zone and its contents have been selected. For example, in some embodiments, if a user double-clicks a mouse button while the mouse point is within the boundary of zone, the visualization engine may be configured to render a marquee-style border around the geometric boundary of the selected zone.

In one or more of the various embodiments, visualization engines may be arranged to generate dashboard user interfaces, such as, dashboard user interface 200, based on interpreting dashboard models (not shown) that defines the zones or objects and how they may be located within the dashboard. Also, in some embodiments, dashboard model may define one or more actions that enable one or more separate user interface objects to interact with other objects or visualizations in the dashboard.

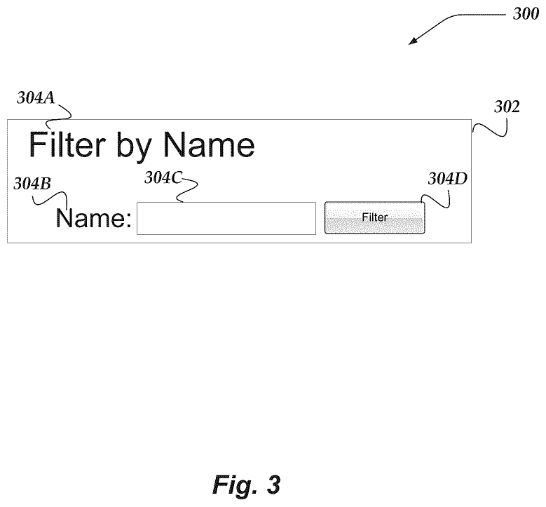

FIG. 3 illustrates a logical representation of zone 300 for copy and paste for dashboard user interfaces in accordance with one or more of the various embodiments. As mentioned above, zones may be data structures that include or reference one or more user interface objects. Further, in some embodiments, zones themselves may support various styling attributes/features, such as, border-style, background color, alignment/layout hints, or the like. In some embodiments, one or more style declaration associated with a zone may cascade to one or more included user interface objects. For example, in some embodiments, a zone may be associated with a default font style. Thus, in this example, one or more objects included in the zone may inherit a font style from the zone default font unless a font for a user interface object is expressly declared.

In this example, for some embodiments, zone 300 includes several user interface objects, such as, label 304A, label 304B, text control 304C, and button 304D. In some embodiments, each user interface object included in a zone may include one or more user interface objects that are included in a dashboard. In this example, if a user activates button 304D, the visualization engine may be arranged to filter data associated with the dashboard (or one of the visualizations included in the dashboard) based on the text included in text control 304C.

In one or more of the various embodiments, dashboard authors may be enabled to associate each object in a zone (or in the dashboard in general) with one or more style attributes that inform the visualization engine how to render the appearance of the controls in the dashboard. Accordingly, in one or more of the various embodiments, if an author would like to duplicate a zone in the same dashboard or another dashboard, manually duplicating the zone and its contents may be difficult or time-consuming. Thus, in some embodiments, visualization engines may be arranged to enable dashboard authors to use copy-paste actions to copy zones within a dashboard and paste them into the dashboard or another dashboard using a system clipboard facility.

As described above, in some embodiments, visualization engines may be arranged to include data structures or other information that represents a zone in a dashboard model.

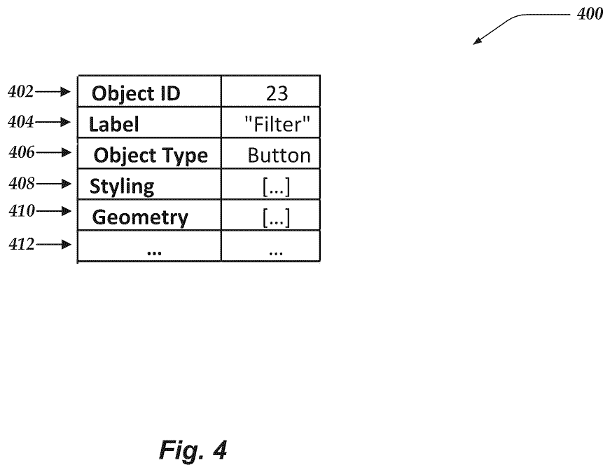

FIG. 4 illustrates a logical schematic of data structure 400 for copy and paste for dashboard user interfaces in accordance with one or more of the various embodiments. In some embodiments, user interface objects may be represented using one or more data structures, such as, data structure 400. In some embodiments, data structures, such as, data structure 400 may include various fields for representing various attributes of user interface objects, including, object identifier field 402, label field 404, object type field 406, styling field 408, geometry field 410, and field 412 which represent one or more additional fields that may be associated with a particular user interface object. For example, a button user interface object may include fields that enable the button to be associated with other controls, visualizations, or actions in the dashboard. In one or more of the various embodiments, visualization engines may be arranged to employ data structures, such as, data structure 400 to represent user interface objects in dashboard models.

Note, in this example, data structure 400 is represented using a table for brevity and clarity. However, one of ordinary skill in the art will appreciate that that other data structures or data formats may be employed to represent user interface objects, including, arrays, lists, structures, database tables/records, JSON objects, XML, files, or the like, without departing from the scope of the innovations disclosed herein. Likewise, in some embodiments, the number of fields, their labeling or positioning may vary without departing from the scope of the innovations disclosed herein.

### Generalized Operations

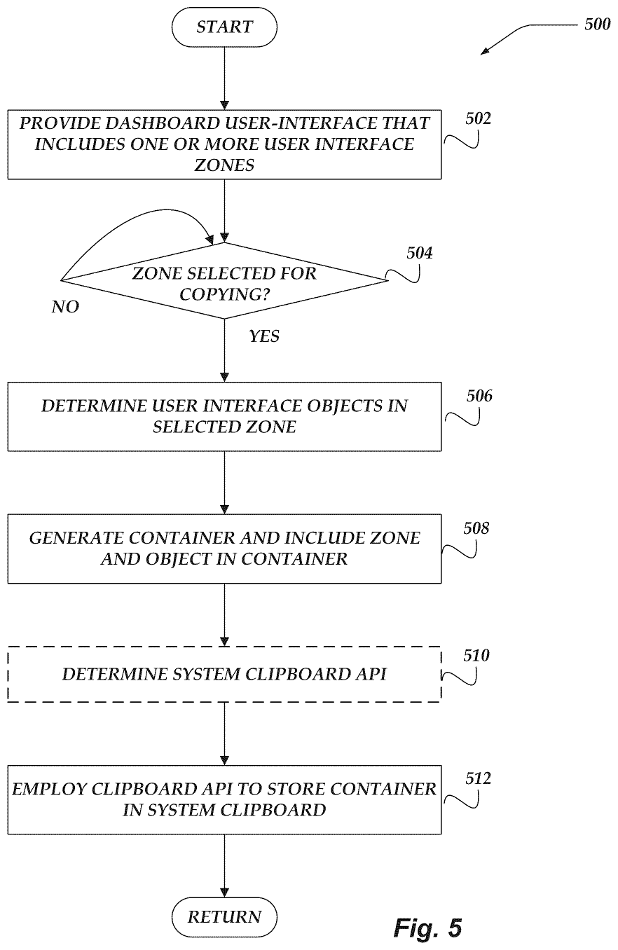

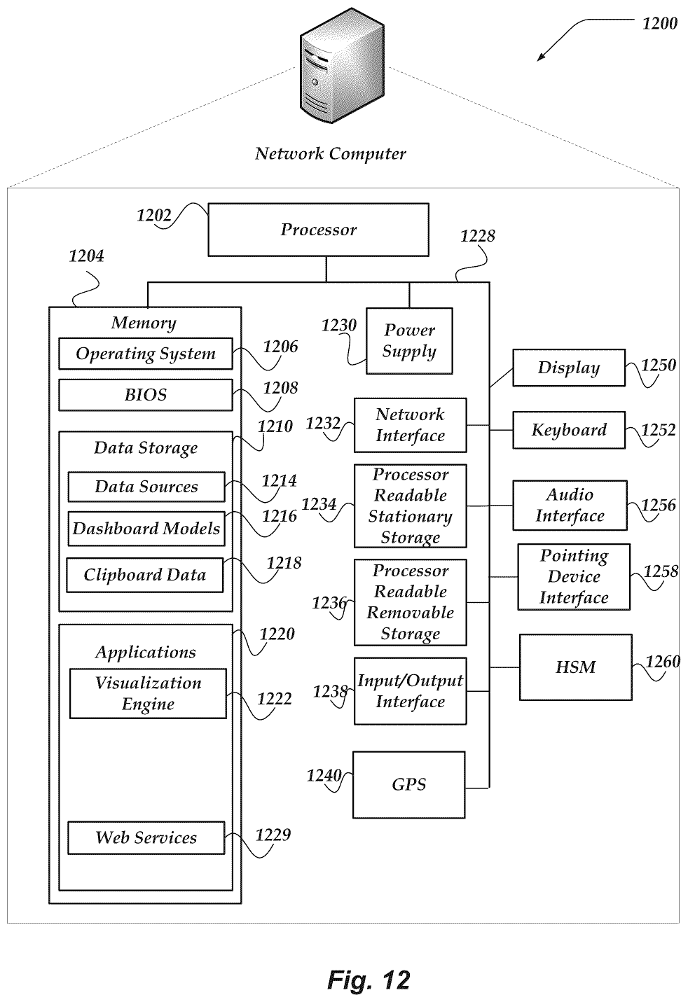

FIGS. 5-9 represents generalized operations for copy and paste for dashboard user interfaces in accordance with one or more of the various embodiments. In one or more of the various embodiments, processes 500, 600, 700, 800, and 900 described in conjunction with FIGS. 5-9 may be implemented by or executed by one or more processors on a single network computer, such as network computer 1200 of FIG. 12. In other embodiments, these processes, or portions thereof, may be implemented by or executed on a plurality of network computers, such as network computer 1200 of FIG. 12. In yet other embodiments, these processes, or portions thereof, may be implemented by or executed on one or more virtualized computers, such as, those in a cloud-based environment. However, embodiments are not so limited and various combinations of network computers, client computers, or the like may be utilized. Further, in one or more of the various embodiments, the processes described in conjunction with FIGS. 5-9 may be used for copy and paste for dashboard user interfaces in accordance with at least one of the various embodiments or architectures such as those described in conjunction with FIGS. 1-4. Further, in one or more of the various embodiments, some or all of the actions performed by processes 500, 600, 700, 800, and 900 may be executed in part by visualization engine 1222 or the like, running on one or more processors of one or more network computers.

FIG. 5 illustrates an overview flowchart for process 500 for copy and paste for dashboard user interfaces in accordance with one or more of the various embodiments. After a start block, at block 502, in one or more of the various embodiments, a dashboard user interface that includes one or more user interface zones may be provided for display. As described above, in some embodiments, visualization platforms may enable authoring user to design interactive collections of one or more visualizations for various analytical needs. In some cases, authors may design dashboards that typical include one or more visualizations that may be directed to a common context or purpose. For example, a business analyst may design a dashboard that includes visualizations of one or more important metrics (e.g., key performance metrics) driven from data sources based on the operation or performance of the organization.

In one or more of the various embodiments, visualization platforms may be arranged to provide dashboard authoring tools that enable user to design dashboards. Accordingly, in some embodiments, authors may select existing dashboards to edit or modify. Likewise, in some embodiments, an author may be enabled to create a ‘blank’ dashboard with the intention to select/design user interface objects to include the dashboard.

As described above, in one or more of the various embodiments, visualization engines may be arranged to enable one or more user interface objects to be grouped in user interface zones. Accordingly, in some embodiments, one or more user interface objects included in the dashboard may be included in a user interface zone.

In some cases, in some embodiments, two or more user interface objects may be grouped together in meaning, context, or appearance. Accordingly, in some embodiments, visualization engines may be arranged to enable user interface objects to be grouped into user interface zones. For example, user interface zone 300 detailed in FIG. 3 groups several related user interface objects into a zone.

In one or more of the various embodiments, visualization engines may be arranged to generate dashboard models that correspond to dashboards displayed in dashboard authoring tools.

At decision block 504, in one or more of the various embodiments, if a zone in the dashboard may be selected for copying, control may flow to block 506; otherwise, control may loop back to decision block 504. In some embodiments, authoring users may determine that they would like to select one or more user interface objects for duplicating in the same dashboard that include the objects or another dashboard.

In one or more of the various embodiments, visualization engines may be arranged to enable authoring users to employ platform supported interactions to indicate their intention to select a zone for copying. For example, in some embodiments, a user may be enabled to employ one or more of mouse pointing devices, track-ball devices, touchscreens, keyboards, or the like, for selecting zones or objects in dashboards.

At block 506, in one or more of the various embodiments, visualization engines may be arranged to determine the one or more user interface objects included in the selected zone. In response to a zone being selected, visualization engines may be arranged to interrogate the data structures that comprise the selected zone to identify the one or more user interface objects that may be included in the selected zone. Also, in some embodiments, visualization engines may be arranged to enable user interface zones to include one or more other user interface zones. Thus, in some cases, visualization engines may recursively iterate through such zones to identify the selected user interface objects. For example, in some embodiments, visualization engines may be arranged to traverse dashboard models that correspond to the display dashboard user interface to determine the zones or user interface objects that have been selected.

At block 508, in one or more of the various embodiments, visualization engines may be arranged to generate a container and include the selected zones and the one or more user interface objects. In one or more of the various embodiments, a container object may be a data structure that enables the selected zones and associated with user interface objects to be serialized into a format that may be compatible with the clipboard system that may be available in the computing environment that the authoring user may be using to design dashboards. In some embodiments, containers may be structured data that enable visualization engines to store sufficient information about selected zone, user interface objects, and so on, to enable the visualization engines to interpret the contents of the container and reconstruct the zone in a dashboard. Accordingly, in some embodiments, containers may include or be associated a dashboard model that may employed to represent the copied zones or objects.

At block 510, in one or more of the various embodiments, optionally, visualization engines may be arranged to determine a system clipboard API. System clipboard APIs may vary depending on the operating system of the computing environment that is hosting the visualization platform. In some embodiments, visualization engines may be arranged to query their host to identify the operating system or clipboard APIs that may be available. Also, in some embodiments, visualization engines may be arranged to determine the particular clipboard API based on configuration information to account for local requirements or local circumstances.

Note, this block is indicated as being optional because in some embodiments, visualization engines may be configured to automatically employ the appropriate clipboard API for a given computing environment/operating system.

At block 512, in one or more of the various embodiments, visualization engines may be arranged to employ the clipboard API to store the container in the system clipboard. In one or more of the various embodiments, visualization engines may provide the container as parameter to the clipboard API. In some embodiments, visualization engines may be arranged to perform one or more actions to transform the container into a data format that may be compatible with the system clipboard. In some embodiments, visualization engines may be arranged to register one or more clipboard handlers that may provide customized support for containers.

Next, in one or more of the various embodiments, control may be returned to a calling process.

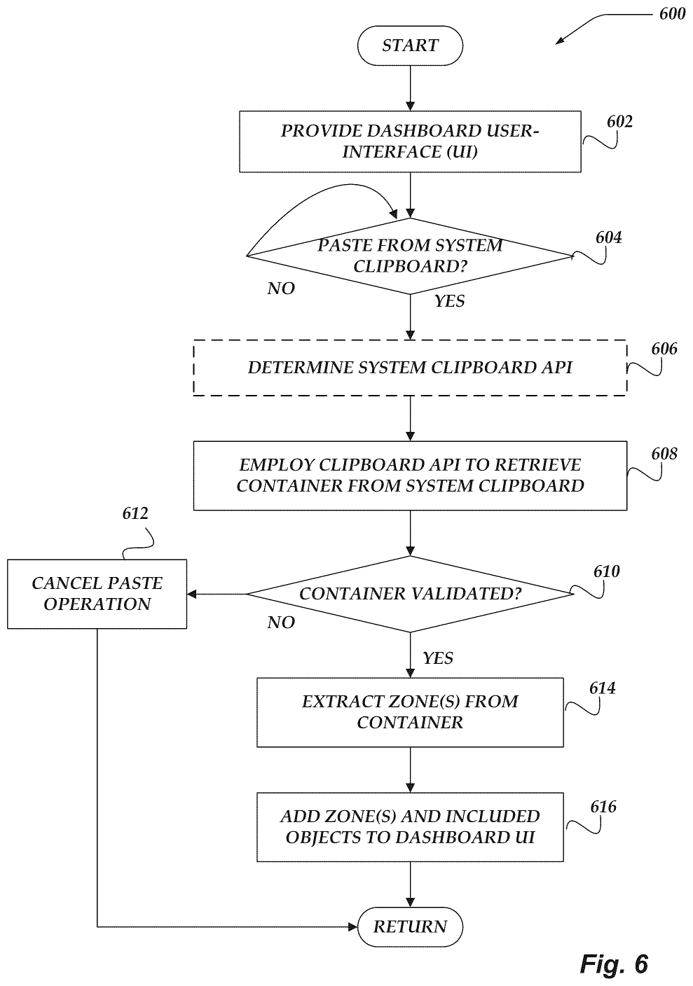

FIG. 6 illustrates a flowchart for process 600 for copy and paste for dashboard user interfaces in accordance with one or more of the various embodiments. After a start block, at block 602, in one or more of the various embodiments, a dashboard user interface that includes one or more user interface zones may be provided for display. As described above, in some embodiments, visualization platforms may be arranged to provide one or more user interfaces that enable users to author dashboards.

At decision block 604, in one or more of the various embodiments, if a user executes a system paste command, control may flow to block 606; otherwise, control may loop back to decision block 604. In some embodiments, paste commands may be provided by an operating system. In some cases, user may initiate a paste command using keystrokes/hotkeys, input device actions (e.g., mouse clicks), contextual menus, or the like. In some cases, paste commands may be unavailable if a system clipboard is empty of data that may be compatible with a given application. Accordingly, in some cases, for some operating systems, applications, such as, dashboard authoring tools may register the one or more data types it supports for copy/pasting with the host operating system. In some embodiments, operating system may enable applications to provide and register one or more handlers, plug-ins, extensions, or the like, to work with system clipboard data types.

In one or more of the various embodiments, different computing platforms may support different types of commands for indicating a paste command. For example, keystrokes/hotkeys for initiating copy/paste actions may vary between types of operating systems.

At block 606, in one or more of the various embodiments, optionally, visualization engines may be arranged to determine an API for the system clipboard. As described above, visualization engines may be arranged to support more than one system clipboard API. In some embodiments, dashboard authoring tools may be compiled to include particular software libraries for particular computing environments. Also, in some embodiments, dashboard authoring tools may be arranged to dynamic load a library, plug-in, extension, configuration information, or the like, to support different clipboard APIs.

Note, this block is indicated as being optional because in some embodiments, visualization engines may be configured to automatically employ the appropriate clipboard API for a given computing environment/operating system.

At block 608, in one or more of the various embodiments, visualization engines may be arranged to employ the clipboard API to obtain the container from the system clipboard. In some embodiments, system clipboard APIs enable the operating system to provide a reference or handle to the data that may be stored in the system clipboard. In some embodiments, system clipboard may expect calling applications (e.g., dashboard authoring tools) to provide or designate a memory buffer or memory location where the clipboard contents may be stored.

At decision block 610, in one or more of the various embodiments, if the container may be determined to be a valid dashboard container, control may flow to block 614; otherwise, control may flow to block 612.

In one or more of the various embodiments, visualization engines may be arranged to validate data obtained from the system clipboard to determine if the data may be a well-formed container. In some embodiments, visualization engines may be arranged to perform one or more actions to evaluate one or more fields or sections in the container. In some embodiments, containers may be configured include one or more fields that store meta-data, such as, time of copying to clipboard, source application/dashboard version, tags/keys/labels that may be validated, or the like. Accordingly, in some embodiments, visualization engines may be arranged to compare values from the container to one or more expected values that may indicate that the data obtained from the clipboard may be a valid container. In some embodiments, visualization engines may be arranged to employ rules, instructions, or the like, provided via configuration information to account for local requirement or local circumstances such as additional or new validation test/requirements for containers.

Also, in some embodiments, visualization engines may be arranged to validate the dashboard model included in the container. Accordingly, in some embodiments, visualization engines may be arranged to traverse the dashboard model in the container to determine if the container include valid zones or objects.

Note, in some cases, data from the clipboard that is not a container may remain consumable by the dashboard authoring tools. For example, a clipboard may have plain text stored in it that a dashboard author may be attempting to paste into a label control in a dashboard. Accordingly, in some embodiments, visualization engines may be arranged to perform other paste actions for other types of clipboard data that may be accepted by the dashboard authoring tools.

Also, in some embodiments, visualization engines may be arranged to perform one or more preliminary actions on the data obtained from the system clipboard to enable the container to be validated. For example, in some embodiments, visualization engines may be arranged compress container data before copying it to a clipboard. Thus, in this example, visualization engines may be arranged to decompress the data obtained from clipboards before attempting to validate the container. For example, in some embodiments, container data may be XML data that is compressed before storing in a clipboard. Thus, in this example, visualization engines may be arranged to decompress the data to provide XML, data that may be processed (e.g., inflated) to instantiate a container or the included dashboard model.

At block 612, in one or more of the various embodiments, visualization engines may be arranged to cancel the paste operation because the container data collected from the system clipboard may not be recognized by the visualization engine. In one or more of the various embodiments, if the clipboard data may not be a container, visualization engines may cancel the paste operation. In some embodiments, visualization engines may be arranged to interrogate system clipboards to determine if a valid container may be present before enabling paste actions in a given context. In some embodiments, visualization engines may be arranged to silently disable the pasting if the data in the clipboard is not a valid container. Thus, in some embodiments, if the clipboard does not have a valid container available, visualization engines may be arranged to automatically hide or disable zone pasting. For example, in some embodiments, if the operating system provides a context menu that includes a ‘paste’ menu item, that menu item may be disabled unless the clipboard is holding a valid container.

At block 614, in one or more of the various embodiments, visualization engines may be arranged to extract one or more zones from the dashboard container. As described above, visualization engines may be arranged to store a dashboard models the represents the copied zones and user interface objects in a container. Accordingly, in some embodiments, visualization engines may be arranged to traverse the dashboard models provided in the container to determine if one or more zones and object that may be available for pasting into the target dashboard.

In one or more of the various embodiments, if zone data found may be in the container, visualization engines may be arranged to transform the zone data into one or more user interface zone objects. In some embodiments, visualization engines may be arranged to employ rules, libraries, instructions, or the like, provided via configuration information to perform the one or more actions to convert zone data from a container to one or more zone objects with one or more embedded user interface objects. Accordingly, in some embodiments, visualization engines may be configured support additional zone type, user interface types, or the like, to account for future versions, local circumstances, local requirements, or the like.

In one or more of the various embodiments, different portions of the container may be indicated with tags, labels, identifiers, or the like, that enable visualization engines to identify the portion of the container data structure that may include user interface zone information. For example, in some embodiments, containers may be organized to include a dashboard model that enables visualization engines to efficiently traverse the dashboard model to identify the zones that may be included the container.

In one or more of the various embodiments, visualization engines may be arranged to provide an API for interrogating containers, creating container objects from clipboard data, extracting zones from containers, extracting user interface objects from containers, reading metadata from containers, or the like. Accordingly, in some embodiments, visualization engines may be arranged to employ libraries, plug-ins, instructions, or the like, provided by configuration information to enable additional container data formats or additional container features to be supported as needed to account for local circumstances or local requirements.

At block 616, in one or more of the various embodiments, visualization engines may be arranged to add the one or more zones and included user interface objects to the dashboard user interface. In some embodiments, visualization engines may be arranged to determine ‘landing’ geometry for the zones being added to the target dashboard. In some embodiments, screen/window coordinates may be provided by user's pointing device. In some cases, for some embodiments, visualization engines may be arranged to assign a default landing location for pasted zones. For example, in some embodiments, visualization engines may be configured temporarily place pasted zones in a the upper right corner of the target dashboard.

Also, in some embodiments, visualization engines may be arranged to modify or adjust where a zone may be placed in the target dashboard based on evaluating the location of other zones or user interface objects that may be present in the target dashboard. In some embodiments, visualization engines may be arranged to determine one or more values to offset the placement of zones to ensure the pasted zones do not hide other zones if possible. Also, in some embodiments, visualization engines may be arranged to employ z-order placement to offset pasted zones from existing zones. For example, in some embodiments, visualization engines may be arranged to ensure that pasted zones may have a higher z-order than other zones.

In some embodiments, visualization engines may be arranged to enable pasted zones to remain movable within the target dashboard until a user confirms the location. Accordingly, in some embodiments, visualization engines may be arranged to display pasted zones with styling (e.g., marquee borders, transparency, color, color saturation, or the like) that indicates that the paste operation has not been finalized.

Also, In some embodiments, visualization engines may be arranged to perform one or more actions to integrate the pasted zones and the embedded user interface objects into the dashboard. In some embodiments, visualization engines may be arranged to modify the identifiers of the pasted objects to be compatible with the identifiers that may already be associated with the target dashboard. Also, in some embodiments, visualization engines may be arranged to register some user interface object types to link up actions or behaviors associated with pasted objects to other actions, objects, or behaviors supported by the target dashboard.

In one or more of the various embodiments, in some cases, zones may be associated with extra data that may be included in the container. For example, in some embodiments, image data may be the extra data for image objects. In some embodiments, visualization engines may be arranged to store a reference to the location where the extra data may be located rather than transferring the bulk of the extra data through the system clipboard. Accordingly, in some embodiments, visualization engines may be arranged to obtain the extra data based on information, such as, URLs, file paths, lookup keys, or the like, that may be included in the container. Thus, in some embodiments, visualization engines may be arranged to obtain the extra data and provide it to the dashboard authoring tools for including in the target dashboard.

Next, in one or more of the various embodiments, control may be returned to a calling process.

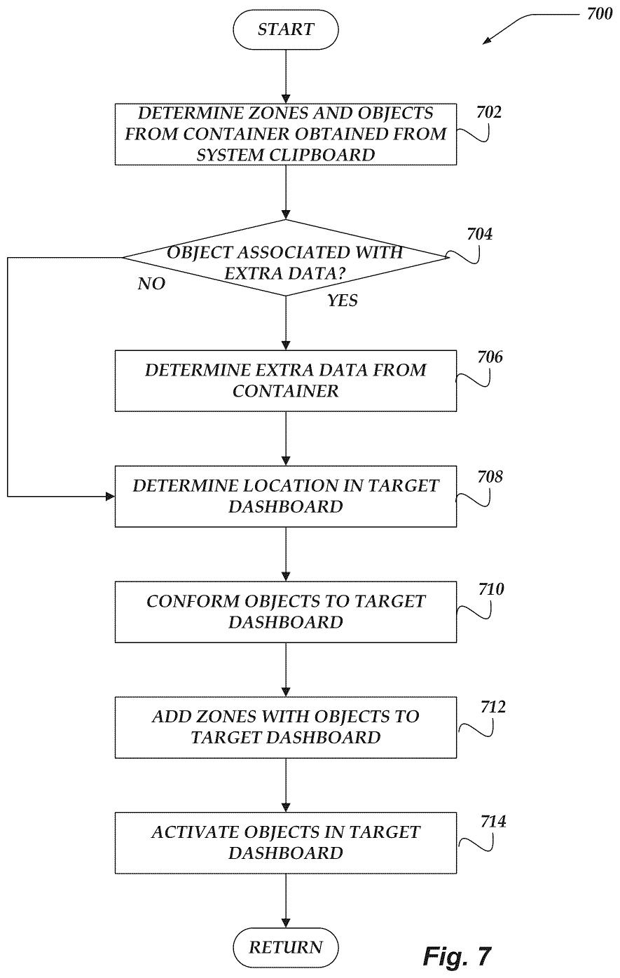

FIG. 7 illustrates a flowchart for process 700 for copy and paste for dashboard user interfaces in accordance with one or more of the various embodiments. After a start block, at block 702, in one or more of the various embodiments, visualization engines may be arranged to determine one or more zones and one or more user interface objects from a container obtained from a system clipboard. As described above, in some embodiments, visualization engines may be arranged to obtain a container from the system clipboard and extract the zone objects and user interface objects included in the container. For example, in some embodiments, containers may include dashboard models that represent the zones or objects included in the container. Thus, for example, in some embodiments, visualization engines may be arranged to traverse that dashboard model to determine the zones or user interface objects for pasting into a target dashboard.

At decision block 704, in one or more of the various embodiments, if a user interface object may be associated with extra data, control may flow to block 706; otherwise, control may flow to block 708. As described above, one or more user interface objects may be associated with extra data. For example, for some embodiments, in some cases, image data for image objects may be stored or located outside of the container itself.

At block 706, in one or more of the various embodiments, visualization engines may be arranged to determine the one or more extra data sources for the one or more user interface objects associated with extra data.

In some embodiments, extra data for user interface objects may be appended to the container that includes its corresponding user interface objects. Also, in some embodiments, the extra data may be included in the container but not in the dashboard model that is included in the container. Also, in some embodiments, extra data for user interface objects may be stored in a separate data store, file system location, or the like, such that the container includes information for locating or obtaining the extra data, such as, links, URIs, file system paths, lookup keys, or the like.

In one or more of the various embodiments, visualization engines may be arranged to provide the extra data to the user interface objects the extra data may be associated with. In some embodiments, instantiating user interface objects may include providing the extra data or a reference/link to the extra data to the relevant user interface objects.

At block 708, in one or more of the various embodiments, visualization engines may be arranged to determine a location in the target dashboard user interface for placing/displaying the one or more zones or user interface objects.

In one or more of the various embodiments, visualization engines may be arranged to execute one or more defined policies for determining locations in the dashboard where the pasted objects may be placed. In some embodiments, visualization engines may be arranged to select a location placement policy based on one or more of the zone type, user interface object type, or the like. In some embodiments, a placement policy may also depend on the geometric size of a given user interface object.

In one or more of the various embodiments, visualization engines may be arranged to employ a location (e.g., screen coordinates, window coordinates, or the like) provided or selected by a user to employ as starting point. For example, if the objects being pasted are not associated with a placement policy, visualization engines may be arranged to place pasted objects at the location selected by the user.

Also, in some embodiments, visualization engines may be arranged to consider the z-order position of objects in the target dashboard. For example, in some embodiments, visualization engines may be arranged to by default determine that the z-order placement for pasted objects may be top of the stack. Also, in some embodiments, policies for some objects may result in the visualization engine determining that those objects should located at the bottom of the stack. For example, if a user interface object type is a background type of object, the visualization engine may be arranged to automatically locate those objects underneath/behind other objects in the target dashboard.

Also, in some embodiments, one or more zones or objects may be located ‘inside’ another existing zone or object. Thus, in some cases, pasted zones or objects may be included as child zones or child objects of other zones or other objects that may be in the target dashboard. Accordingly, in some embodiments, visualization engines may be arranged to determine if zones or objects support children (e.g., container zones or container objects) based on one or more flags or other indicators that may be associated with one or more of a zone, a zone type, an object, an object type, or the like.

At block 710, in on or more of the various embodiments, visualization engines may be arranged to conform the one or more user interface objects to the target dashboard. In some cases, one or more user interface objects may require modification or updating to make them compatible with the target dashboard. In some embodiments, this may be for various reasons, such as, version changes/mismatch, localization, or the like.

Also, in some embodiments, visualization engines may be arranged to assign identifiers (object identifiers) to objects that comprise dashboards. Accordingly, in some embodiments, visualization engines may be arranged to reconcile object identifiers that may be associated with paste objects to the identifiers of objects that may already be present in the target dashboard. In some embodiments, visualization engines may be arranged to renumber object identifiers for the entire target dashboard each time new objects may be added. Also, in some embodiments, if object identifiers are numeric, visualization engines may be arranged to determine which existing object in the target dashboard has the greatest values object identifier. Accordingly, in some embodiments, visualization engines may be arranged to sequentially set the object identifiers of the pasted objects to come after the highest identifier value in the target dashboard.

Also, in one or more of the various embodiments, one or more user interface objects may require additional actions, such as, registration to enable one or more dashboard features, such as, enabling particular user interface object to integrate with other objects in the dashboard. Accordingly, in some embodiments, visualization engines may be arranged to automatically register objects as needed.

In one or more of the various embodiments, in some cases, one or more user interface objects may be registered to enable them to appear in other lists, collections, or the like, provided by dashboard authoring tools. For example, in some embodiments, an authoring tool may provide popup windows or menus that list one or more user interface objects that may be identified by registration to support various actions.

At block 712, in one or more of the various embodiments, visualization engines may be arranged to add the one or more zones with the one or more user interface objects to the target dashboard. In some embodiments, visualization engines may be arranged to employ one or more dashboard APIs to include the one or more zones or one or more user interface objects in the target dashboard. Further, in some embodiments, zones or objects that are pasted as child zones or child objects may be inserted in the target dashboard.

In one or more of the various embodiments, visualization engines may be arranged to include the one or more zones or one or more user interface objects in the dashboard model that corresponds to the target dashboard.

At block 714, in one or more of the various embodiments, visualization engines may be arranged to activate the one or more user interface objects in the target dashboard.

In one or more of the various embodiments, visualization engines may be arranged to scan the zones and user interface objects in the target dashboard to determine which zones or objects may be activated. In this context, activating zone or activating a user interface object may result in the appearance/styling of the zones or objects being modified to appear ‘ready’. In contrast, in some embodiments, zones or objects that are not activated may be styled to reflect that they may not be ready to use. For example, if a button object is pasted in a target dashboard and its ‘press/click’ action is associated with a valid target, that button object may remain in a de-activated or disabled appearance until the dashboard author assigns a function, object, or the like, to the button object's action.

Thus, in some embodiments, pasting some zones or some user interface objects into a dashboard may preserve their text content, color, fonts, or other style/layout characteristics while not preserving all their integration with other objects or the dashboard itself. Accordingly, in some embodiments, dashboard authoring tools may be arranged to highlight to a user that one or more pasted objects require additional attention to enable them to be activated in the target dashboard.

Next, in one or more of the various embodiments, control may be returned to a calling process.

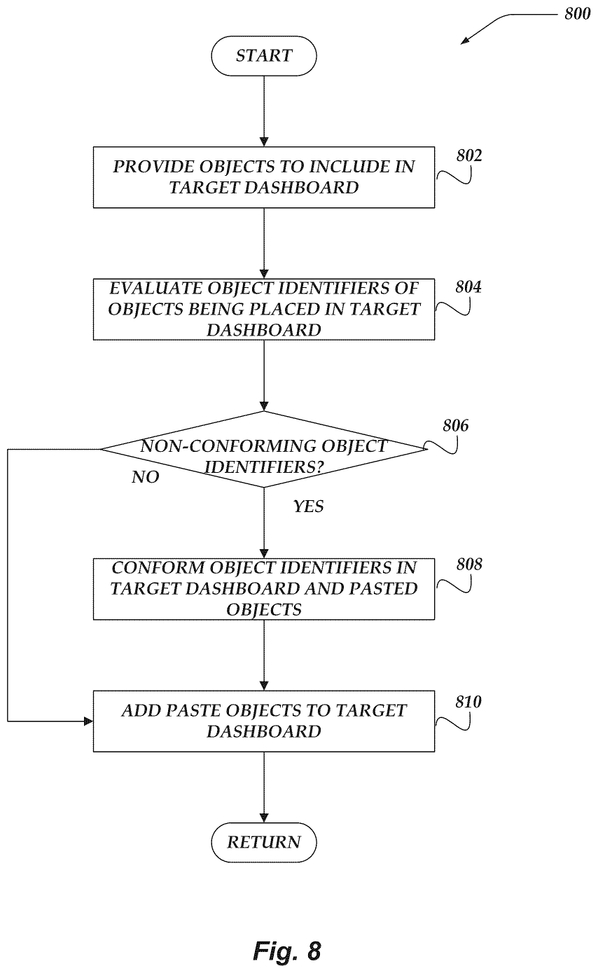

FIG. 8 illustrates a flowchart for process 800 for copy and paste for dashboard user interfaces in accordance with one or more of the various embodiments. After a start block, at block 802, in one or more of the various embodiments, visualization engines may determine one or more user interface objects that may be included in a target dashboard. As described above, in some embodiments, visualization engines may be arranged to obtain a container from a system clipboard and from the container determine one or more user interface objects that may be added (e.g., pasted) into a target dashboard.

At block 804, in one or more of the various embodiments, visualization engines may be arranged to evaluate object identifiers associated with the user interface objects being pasted with other object identifiers included in the target dashboard. In some cases, the target dashboard may already include one or more other user interface objects that may be grouped into zones or otherwise.

In one or more of the various embodiments, visualization engines may employ object identifiers to distinguish individual objects. In some cases, visualization engines may be arranged to assign particular identifiers to each object that is included in a dashboard.

Accordingly, in some embodiments, if the objects being pasted in the target dashboard were assigned identifiers before they were copied to the system clipboard, those objects may be associated with the same identifiers if being pasted.

Thus, in some embodiments, visualization engines may be arranged to evaluate the identifiers associated with the incoming objects to determine if they may be compatible with the identifiers or identifier policies of the target dashboard.

For example, in some embodiments, a target dashboard may include four objects with the identifiers, 100, 101, 102, and 103. Thus, in this example, if the pasted objects are associated with identifiers 102, 103, or the like, the identifiers of the incoming objects are in conflict with the identifiers already present in the target dashboard.

At decision block 806, in one or more of the various embodiments, if there may be one or more non-conforming object identifiers, control may flow to block 808; other control may loop to block 810. In some cases, in some embodiments, the incoming object may be associated with identifiers that conform to identifier policies associated with the target dashboard. For example, if a target dashboard may not have any included objects, the identifiers of the incoming object may not conflict because there may be no existing objects to cause a conflict.

At block 808, in one or more of the various embodiments, visualization engines may be arranged to conform the one or more user interface objects associated with the non-conforming identifiers to the target dashboard. In some embodiments, visualization engines may be arranged to modify one or more of the identifiers associated with the incoming objects or the existing objects in the target dashboard.

In one or more of the various embodiments, if object identifiers may be integers, visualization engines may be arranged to determine a highest value object identifier from the existing objects that may be in the target dashboard. Accordingly, in some embodiments, visualization engines may be arranged to sequentially assign identifiers to the incoming objects with values greater than the highest identifier values of the existing objects.

In some embodiments, visualization engines may be arranged to preserve the relative identifier order of the identifiers of the incoming object starting from a first determined value. For example, if the incoming objects include Object A with identifier 415, Object B with identifier 420, and Object C with identifier 425, a visualization engine that has determined the first available identifier for incoming objects as 200 may assign Object A to identifier value 200, Object B to identifier value 201, and Object C to identifier value 202, or the like, to preserve the identifier order of the incoming objects.

In some embodiments, if there may be no existing object in the target dashboard, visualization engines may be arranged to assign a starting value, such as, ‘1’ to the incoming object with the lowest valued identifier, and assign ‘2’ to the object with the next higher valued identifier, or the like.

In some embodiments, visualization engines may be arranged to enable dashboard authors or other administrators to select from one or more identifier policies that may be applied to the incoming objects. For example, in some embodiments, visualization engines may be arranged to require object identifiers are within a set range of values. Also, for example, in some embodiments, visualization engines may be configured to reset all the identifiers in the target dashboard if objects are pasted into it. Also, for example, in some embodiments, visualization engines may be arranged to preserve the incoming object identifier values if lowest valued identifier of the incoming objects if greater than the highest valued identifier of the existing objects in the target dashboard, visualization engines may be arranged to preserve the incoming object identifiers. Accordingly, in some embodiments, visualization engines may be arranged to employ rules, instructions, options, or the like, provided via configuration information to account for local requirements or local circumstances that may be associated with object identifiers.

At block 810, in one or more of the various embodiments, visualization engines may be arranged to add the one or more user interface objects to the target dashboard.

In some embodiments, if the object identifiers of the incoming object conform to the identifiers or identifier policies associated with the target dashboard, visualization engines may be arranged to include the incoming objects in the target dashboard.

Next, in one or more of the various embodiments, control may be returned to a calling process.

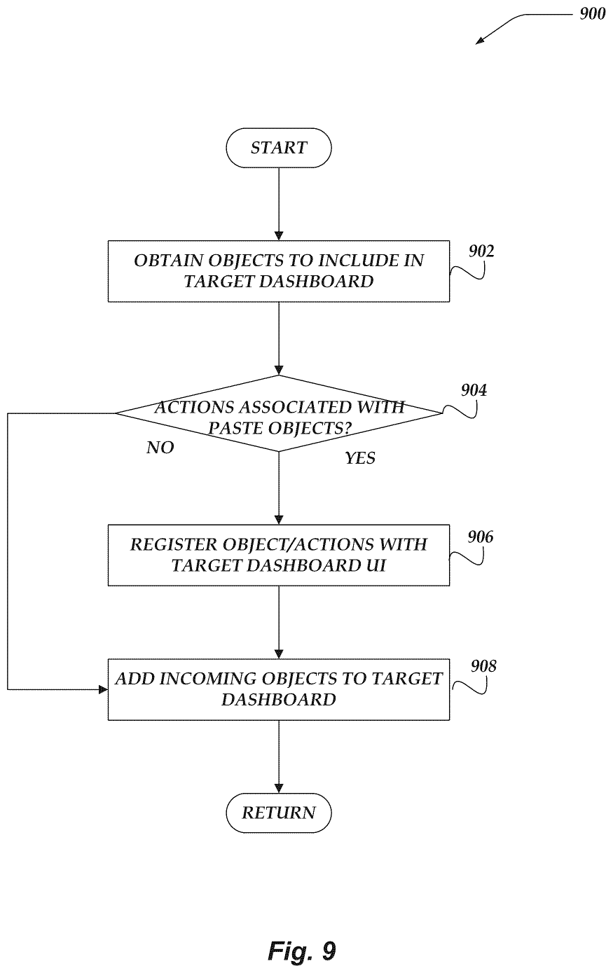

FIG. 9 illustrates a flowchart for process 900 for copy and paste for dashboard user interfaces in accordance with one or more of the various embodiments. After a start block, at block 902, in one or more of the various embodiments, visualization engines may be arranged to obtain one or more user interface objects to include in a target dashboard.

As described above, in some embodiments, visualization engines may be arranged to obtain a container from a system clipboard and from the container determine one or more user interface objects that may be added (e.g., pasted) into a target dashboard.

At decision block 904, in one or more of the various embodiments, if one or more actions may be associated with the one or more user interface objects being pasted into the dashboard, control may flow to block 906; otherwise, control may flow to block 908. In some embodiments, some object types, such as, button controls, pick list controls, radio button groups, or the like, may be associated with triggering an action in dashboards. In some embodiments, an action may include: activating or deactivating other controls; showing or hiding other controls, visualizations, or zones; executing a custom script/function; or the like.

Further, in some embodiments, to facilitate interaction among objects in a dashboard, visualization engines may be arranged to maintain lists of objects that may trigger actions. For example, in some embodiments, a dashboard authoring tool may be arranged to display a list of objects in a dashboard that may be linked or associated with other objects or system provided features. Accordingly, in some embodiments, authoring tools may provide user interfaces that enable dashboard authors to readily identify objects that may be available for associating with actions. Thus, in some embodiments, visualization engines may be arranged to determine if one or more of the incoming objects may require registering with one or more registries provided by the visualization engine. In some embodiments, one or more particular object types may require registration. Thus, in some embodiments, visualization engines may be arranged to determine if an object requires registration with the dashboard or dashboard authoring tool based on the object type of the incoming object.

At block 906, in one or more of the various embodiments, visualization engines may be arranged to register the one or more user interface objects associated with actions with the target dashboard. In one or more of the various embodiments, if one or more incoming object may require registration, visualization engines may determine an API provided by visualization platforms or dashboard authoring tools that may be executed to register those objects.

At block 908, in one or more of the various embodiments, visualization engines may be arranged to add the one or more user interface incoming objects to the target dashboard. As described above, visualization engines may be arranged to include the incoming objects into a dashboard model that corresponds to the target dashboard.

Next, in one or more of the various embodiments, control may be returned to a calling process.

It will be understood that each block in each flowchart illustration, and combinations of blocks in each flowchart illustration, can be implemented by computer program instructions. These program instructions may be provided to a processor to produce a machine, such that the instructions, which execute on the processor, create means for implementing the actions specified in each flowchart block or blocks. The computer program instructions may be executed by a processor to cause a series of operational steps to be performed by the processor to produce a computer-implemented process such that the instructions, which execute on the processor, provide steps for implementing the actions specified in each flowchart block or blocks. The computer program instructions may also cause at least some of the operational steps shown in the blocks of each flowchart to be performed in parallel. Moreover, some of the steps may also be performed across more than one processor, such as might arise in a multi-processor computer system. In addition, one or more blocks or combinations of blocks in each flowchart illustration may also be performed concurrently with other blocks or combinations of blocks, or even in a different sequence than illustrated without departing from the scope or spirit of the invention.

Accordingly, each block in each flowchart illustration supports combinations of means for performing the specified actions, combinations of steps for performing the specified actions and program instruction means for performing the specified actions. It will also be understood that each block in each flowchart illustration, and combinations of blocks in each flowchart illustration, can be implemented by special purpose hardware-based systems, which perform the specified actions or steps, or combinations of special purpose hardware and computer instructions. The foregoing example should not be construed as limiting or exhaustive, but rather, an illustrative use case to show an implementation of at least one of the various embodiments of the invention.

Further, in one or more embodiments (not shown in the figures), the logic in the illustrative flowcharts may be executed using an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. In one or more embodiments, a microcontroller may be arranged to directly execute its own embedded logic to perform actions and access its own internal memory and its own external Input and Output Interfaces (e.g., hardware pins or wireless transceivers) to perform actions, such as System On a Chip (SOC), or the like.

### Illustrated Operating Environment

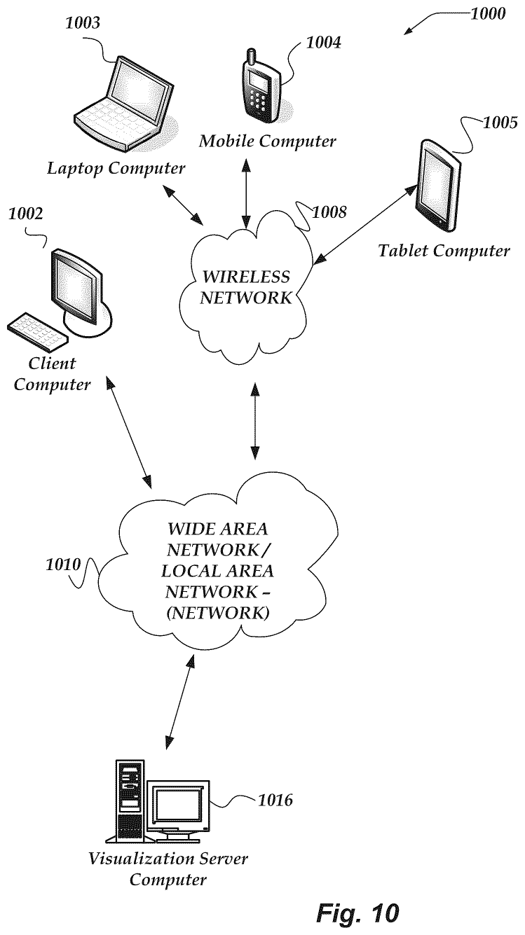

FIG. 10 shows components of one embodiment of an environment in which embodiments of these innovations may be practiced. Not all of the components may be required to practice the invention, and variations in the arrangement and type of the components may be made without departing from the spirit or scope of the invention. As shown, system 1000 of FIG. 10 includes local area networks (LANs)/wide area networks (WANs) —(network) 1010, wireless network 1008, client computers 1002-1005, visualization server computer 1016, or the like.

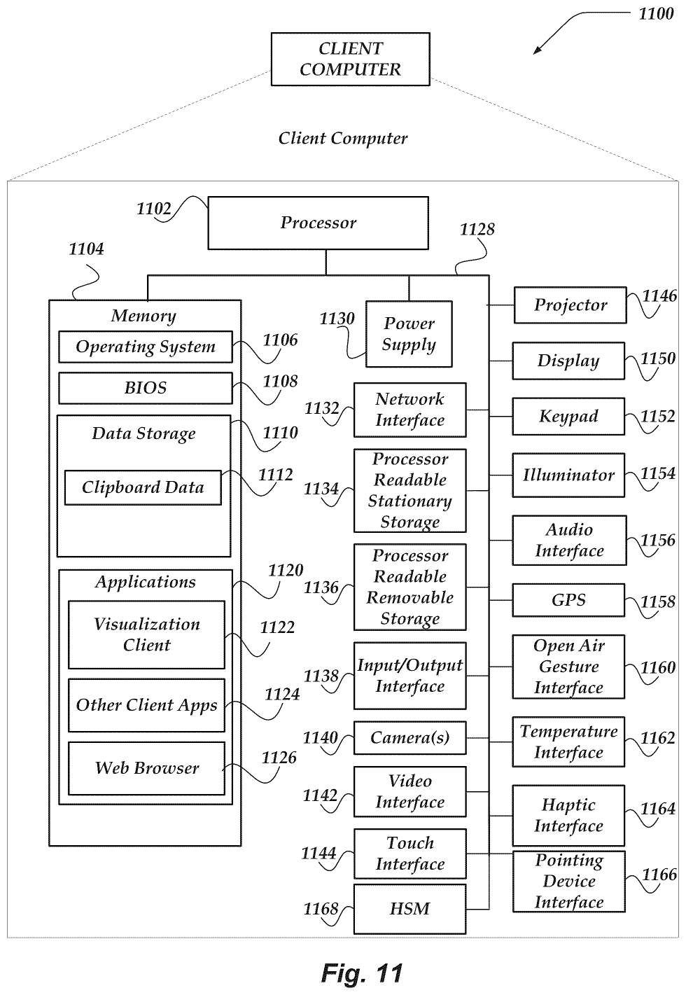

At least one embodiment of client computers 1002-1005 is described in more detail below in conjunction with FIG. 11. In one embodiment, at least some of client computers 1002-1005 may operate over one or more wired or wireless networks, such as networks 1008, or 1010. Generally, client computers 1002-1005 may include virtually any computer capable of communicating over a network to send and receive information, perform various online activities, offline actions, or the like. In one embodiment, one or more of client computers 1002-1005 may be configured to operate within a business or other entity to perform a variety of services for the business or other entity. For example, client computers 1002-1005 may be configured to operate as a web server, firewall, client application, media player, mobile telephone, game console, desktop computer, or the like. However, client computers 1002-1005 are not constrained to these services and may also be employed, for example, as for end-user computing in other embodiments. It should be recognized that more or less client computers (as shown in FIG. 10) may be included within a system such as described herein, and embodiments are therefore not constrained by the number or type of client computers employed.

Computers that may operate as client computer 1002 may include computers that typically connect using a wired or wireless communications medium such as personal computers, multiprocessor systems, microprocessor-based or programmable electronic devices, network PCs, or the like. In some embodiments, client computers 1002-1005 may include virtually any portable computer capable of connecting to another computer and receiving information such as, laptop computer 1003, mobile computer 1004, tablet computers 1005, or the like. However, portable computers are not so limited and may also include other portable computers such as cellular telephones, display pagers, radio frequency (RF) devices, infrared (IR) devices, Personal Digital Assistants (PDAs), handheld computers, wearable computers, integrated devices combining one or more of the preceding computers, or the like. As such, client computers 1002-1005 typically range widely in terms of capabilities and features. Moreover, client computers 1002-1005 may access various computing applications, including a browser, or other web-based application.

A web-enabled client computer may include a browser application that is configured to send requests and receive responses over the web. The browser application may be configured to receive and display graphics, text, multimedia, and the like, employing virtually any web-based language. In one embodiment, the browser application is enabled to employ JavaScript, HyperText Markup Language (HTML), eXtensible Markup Language (XML), JavaScript Object Notation (JSON), Cascading Style Sheets (CS S), or the like, or combination thereof, to display and send a message. In one embodiment, a user of the client computer may employ the browser application to perform various activities over a network (online). However, another application may also be used to perform various online activities.

Client computers 1002-1005 also may include at least one other client application that is configured to receive or send content between another computer. The client application may include a capability to send or receive content, or the like. The client application may further provide information that identifies itself, including a type, capability, name, and the like. In one embodiment, client computers 1002-1005 may uniquely identify themselves through any of a variety of mechanisms, including an Internet Protocol (IP) address, a phone number, Mobile Identification Number (MIN), an electronic serial number (ESN), a client certificate, or other device identifier. Such information may be provided in one or more network packets, or the like, sent between other client computers, visualization server computer 1016, or other computers.

Client computers 1002-1005 may further be configured to include a client application that enables an end-user to log into an end-user account that may be managed by another computer, such as visualization server computer 1016, or the like. Such an end-user account, in one non-limiting example, may be configured to enable the end-user to manage one or more online activities, including in one non-limiting example, project management, software development, system administration, configuration management, search activities, social networking activities, browse various websites, communicate with other users, or the like. Also, client computers may be arranged to enable users to display reports, interactive user-interfaces, or results provided by visualization server computer 1016, or the like.

Wireless network 1008 is configured to couple client computers 1003-1005 and its components with network 1010. Wireless network 1008 may include any of a variety of wireless sub-networks that may further overlay stand-alone ad-hoc networks, and the like, to provide an infrastructure-oriented connection for client computers 1003-1005. Such sub-networks may include mesh networks, Wireless LAN (WLAN) networks, cellular networks, and the like. In one embodiment, the system may include more than one wireless network.

Wireless network 1008 may further include an autonomous system of terminals, gateways, routers, and the like connected by wireless radio links, and the like. These connectors may be configured to move freely and randomly and organize themselves arbitrarily, such that the topology of wireless network 1008 may change rapidly.

Wireless network 1008 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile computers, such as client computers 1003-1005 with various degrees of mobility. In one non-limiting example, wireless network 1008 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 1008 may include virtually any wireless communication mechanism by which information may travel between client computers 1003-1005 and another computer, network, a cloud-based network, a cloud instance, or the like.

Network 1010 is configured to couple network computers with other computers, including, visualization server computer 1016, client computers 1002, and client computers 1003-1005 through wireless network 1008, or the like. Network 1010 is enabled to employ any form of computer readable media for communicating information from one electronic device to another. Also, network 1010 can include the Internet in addition to local area networks (LANs), wide area networks (WANs), direct connections, such as through a universal serial bus (USB) port, Ethernet port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 1010 may be configured to transport information of an Internet Protocol (IP).

Additionally, communication media typically embodies computer readable instructions, data structures, program modules, or other transport mechanism and includes any information non-transitory delivery media or transitory delivery media. By way of example, communication media includes wired media such as twisted pair, coaxial cable, fiber optics, wave guides, and other wired media and wireless media such as acoustic, RF, infrared, and other wireless media.

Also, one embodiment of visualization server computer 1016 is described in more detail below in conjunction with FIG. 12. Although FIG. 10 illustrates visualization server computer 1016 or the like, as a single computer, the innovations or embodiments are not so limited. For example, one or more functions of visualization server computer 1016, or the like, may be distributed across one or more distinct network computers. Moreover, in one or more embodiments, visualization server computer 1016 may be implemented using a plurality of network computers. Further, in one or more of the various embodiments, visualization server computer 1016, or the like, may be implemented using one or more cloud instances in one or more cloud networks. Accordingly, these innovations and embodiments are not to be construed as being limited to a single environment, and other configurations, and other architectures are also envisaged.

### Illustrative Client Computer

FIG. 11 shows one embodiment of client computer 1100 that may include many more or less components than those shown. Client computer 1100 may represent, for example, one or more embodiment of mobile computers or client computers shown in FIG. 10.

Client computer 1100 may include processor 1102 in communication with memory 1104 via bus 1128. Client computer 1100 may also include power supply 1130, network interface 1132, audio interface 1156, display 1150, keypad 1152, illuminator 1154, video interface 1142, input/output interface 1138, haptic interface 1164, global positioning systems (GPS) receiver 1158, open air gesture interface 1160, temperature interface 1162, camera(s) 1140, projector 1146, pointing device interface 1166, processor-readable stationary storage device 1134, and processor-readable removable storage device 1136. Client computer 1100 may optionally communicate with a base station (not shown), or directly with another computer. And in one embodiment, although not shown, a gyroscope may be employed within client computer 1100 to measuring or maintaining an orientation of client computer 1100.

Power supply 1130 may provide power to client computer 1100. A rechargeable or non-rechargeable battery may be used to provide power. The power may also be provided by an external power source, such as an AC adapter or a powered docking cradle that supplements or recharges the battery.

Network interface 1132 includes circuitry for coupling client computer 1100 to one or more networks, and is constructed for use with one or more communication protocols and technologies including, but not limited to, protocols and technologies that implement any portion of the OSI model for mobile communication (GSM), CDMA, time division multiple access (TDMA), UDP, TCP/IP, SMS, MMS, GPRS, WAP, UWB, WiMax, SIP/RTP, GPRS, EDGE, WCDMA, LTE, UMTS, OFDM, CDMA2000, EV-DO, HSDPA, or any of a variety of other wireless communication protocols. Network interface 1132 is sometimes known as a transceiver, transceiving device, or network interface card (MC).

Audio interface 1156 may be arranged to produce and receive audio signals such as the sound of a human voice. For example, audio interface 1156 may be coupled to a speaker and microphone (not shown) to enable telecommunication with others or generate an audio acknowledgment for some action. A microphone in audio interface 1156 can also be used for input to or control of client computer 1100, e.g., using voice recognition, detecting touch based on sound, and the like.

Display 1150 may be a liquid crystal display (LCD), gas plasma, electronic ink, light emitting diode (LED), Organic LED (OLED) or any other type of light reflective or light transmissive display that can be used with a computer. Display 1150 may also include a touch interface 1144 arranged to receive input from an object such as a stylus or a digit from a human hand, and may use resistive, capacitive, surface acoustic wave (SAW), infrared, radar, or other technologies to sense touch or gestures.

Projector 1146 may be a remote handheld projector or an integrated projector that is capable of projecting an image on a remote wall or any other reflective object such as a remote screen.

Video interface 1142 may be arranged to capture video images, such as a still photo, a video segment, an infrared video, or the like. For example, video interface 1142 may be coupled to a digital video camera, a web-camera, or the like. Video interface 1142 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 1152 may comprise any input device arranged to receive input from a user. For example, keypad 1152 may include a push button numeric dial, or a keyboard. Keypad 1152 may also include command buttons that are associated with selecting and sending images.

Illuminator 1154 may provide a status indication or provide light. Illuminator 1154 may remain active for specific periods of time or in response to event messages. For example, when illuminator 1154 is active, it may back-light the buttons on keypad 1152 and stay on while the client computer is powered. Also, illuminator 1154 may back-light these buttons in various patterns when particular actions are performed, such as dialing another client computer. Illuminator 1154 may also cause light sources positioned within a transparent or translucent case of the client computer to illuminate in response to actions.

Further, client computer 1100 may also comprise hardware security module (HSM) 1168 for providing additional tamper resistant safeguards for generating, storing, or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 1168 may be a stand-alone computer, in other cases, HSM 1168 may be arranged as a hardware card that may be added to a client computer.

Client computer 1100 may also comprise input/output interface 1138 for communicating with external peripheral devices or other computers such as other client computers and network computers. The peripheral devices may include an audio headset, virtual reality headsets, display screen glasses, remote speaker system, remote speaker and microphone system, and the like. Input/output interface 1138 can utilize one or more technologies, such as Universal Serial Bus (USB), Infrared, WiFi, WiMax, Bluetooth™, and the like.

Input/output interface 1138 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to client computer 1100.

Haptic interface 1164 may be arranged to provide tactile feedback to a user of the client computer. For example, the haptic interface 1164 may be employed to vibrate client computer 1100 in a particular way when another user of a computer is calling. Temperature interface 1162 may be used to provide a temperature measurement input or a temperature changing output to a user of client computer 1100. Open air gesture interface 1160 may sense physical gestures of a user of client computer 1100, for example, by using single or stereo video cameras, radar, a gyroscopic sensor inside a computer held or worn by the user, or the like. Camera 1140 may be used to track physical eye movements of a user of client computer 1100.

GPS transceiver 1158 can determine the physical coordinates of client computer 1100 on the surface of the Earth, which typically outputs a location as latitude and longitude values. GPS transceiver 1158 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of client computer 1100 on the surface of the Earth. It is understood that under different conditions, GPS transceiver 1158 can determine a physical location for client computer 1100. In one or more embodiments, however, client computer 1100 may, through other components, provide other information that may be employed to determine a physical location of the client computer, including for example, a Media Access Control (MAC) address, IP address, and the like.

In at least one of the various embodiments, applications, such as, operating system 1106, visualization client 1122, other client apps 1124, web browser 1126, or the like, may be arranged to employ geo-location information to select one or more localization features, such as, time zones, languages, currencies, calendar formatting, or the like. Localization features may be used in display objects, data models, data objects, user-interfaces, reports, as well as internal processes or databases. In at least one of the various embodiments, geo-location information used for selecting localization information may be provided by GPS 1158. Also, in some embodiments, geolocation information may include information provided using one or more geolocation protocols over the networks, such as, wireless network 1308 or network 1310.

Human interface components can be peripheral devices that are physically separate from client computer 1100, allowing for remote input or output to client computer 1100. For example, information routed as described here through human interface components such as display 1150 or keyboard 1152 can instead be routed through network interface 1132 to appropriate human interface components located remotely. Examples of human interface peripheral components that may be remote include, but are not limited to, audio devices, pointing devices, keypads, displays, cameras, projectors, and the like. These peripheral components may communicate over a Pico Network such as Bluetooth™, Zigbee™ and the like. One non-limiting example of a client computer with such peripheral human interface components is a wearable computer, which might include a remote pico projector along with one or more cameras that remotely communicate with a separately located client computer to sense a user's gestures toward portions of an image projected by the pico projector onto a reflected surface such as a wall or the user's hand.

A client computer may include web browser application 1126 that is configured to receive and to send web pages, web-based messages, graphics, text, multimedia, and the like. The client computer's browser application may employ virtually any programming language, including a wireless application protocol messages (WAP), and the like. In one or more embodiments, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), HTML5, and the like.

Memory 1104 may include RAM, ROM, or other types of memory. Memory 1104 illustrates an example of computer-readable storage media (devices) for storage of information such as computer-readable instructions, data structures, program modules or other data. Memory 1104 may store BIOS 1108 for controlling low-level operation of client computer 1100. The memory may also store operating system 1106 for controlling the operation of client computer 1100. It will be appreciated that this component may include a general-purpose operating system such as a version of UNIX, or Linux®, or a specialized client computer communication operating system such as Windows Phone™, or the Symbian® operating system. The operating system may include, or interface with a Java virtual machine module that enables control of hardware components or operating system operations via Java application programs.

Memory 1104 may further include one or more data storage 1110, which can be utilized by client computer 1100 to store, among other things, applications 1120, clipboard data 1112 or other data. For example, data storage 1110 may also be employed to store information that describes various capabilities of client computer 1100. The information may then be provided to another device or computer based on any of a variety of methods, including being sent as part of a header during a communication, sent upon request, or the like. Data storage 1110 may also be employed to store social networking information including address books, buddy lists, aliases, user profile information, or the like. Data storage 1110 may further include program code, data, algorithms, and the like, for use by a processor, such as processor 1102 to execute and perform actions. In one embodiment, at least some of data storage 1110 might also be stored on another component of client computer 1100, including, but not limited to, non-transitory processor-readable removable storage device 1136, processor-readable stationary storage device 1134, or even external to the client computer.

Applications 1120 may include computer executable instructions which, when executed by client computer 1100, transmit, receive, or otherwise process instructions and data. Applications 1120 may include, for example, visualization client 1122, other client applications 1124, web browser 1126, or the like. Client computers may be arranged to exchange communications one or more servers.

Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, visualization applications, and so forth.

Additionally, in one or more embodiments (not shown in the figures), client computer 1100 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), client computer 1100 may include one or more hardware micro-controllers instead of CPUs. In one or more embodiments, the one or more micro-controllers may directly execute their own embedded logic to perform actions and access its own internal memory and its own external Input and Output Interfaces (e.g., hardware pins or wireless transceivers) to perform actions, such as System On a Chip (SOC), or the like.

### Illustrative Network Computer

FIG. 12 shows one embodiment of network computer 1200 that may be included in a system implementing one or more of the various embodiments. Network computer 1200 may include many more or less components than those shown in FIG. 12. However, the components shown are sufficient to disclose an illustrative embodiment for practicing these innovations. Network computer 1200 may represent, for example, one embodiment of at least one of visualization server computer 1016, or the like, of FIG. 10.

Network computers, such as, network computer 1200 may include a processor 1202 that may be in communication with a memory 1204 via a bus 1228. In some embodiments, processor 1202 may be comprised of one or more hardware processors, or one or more processor cores. In some cases, one or more of the one or more processors may be specialized processors designed to perform one or more specialized actions, such as, those described herein. Network computer 1200 also includes a power supply 1230, network interface 1232, audio interface 1256, display 1250, keyboard 1252, input/output interface 1238, processor-readable stationary storage device 1234, and processor-readable removable storage device 1236. Power supply 1230 provides power to network computer 1200.

Network interface 1232 includes circuitry for coupling network computer 1200 to one or more networks, and is constructed for use with one or more communication protocols and technologies including, but not limited to, protocols and technologies that implement any portion of the Open Systems Interconnection model (OSI model), global system for mobile communication (GSM), code division multiple access (CDMA), time division multiple access (TDMA), user datagram protocol (UDP), transmission control protocol/Internet protocol (TCP/IP), Short Message Service (SMS), Multimedia Messaging Service (MMS), general packet radio service (GPRS), WAP, ultra-wide band (UWB), IEEE 802.16 Worldwide Interoperability for Microwave Access (WiMax), Session Initiation Protocol/Real-time Transport Protocol (SIP/RTP), or any of a variety of other wired and wireless communication protocols. Network interface 1232 is sometimes known as a transceiver, transceiving device, or network interface card (NIC). Network computer 1200 may optionally communicate with a base station (not shown), or directly with another computer.

Audio interface 1256 is arranged to produce and receive audio signals such as the sound of a human voice. For example, audio interface 1256 may be coupled to a speaker and microphone (not shown) to enable telecommunication with others or generate an audio acknowledgment for some action. A microphone in audio interface 1256 can also be used for input to or control of network computer 1200, for example, using voice recognition.

Display 1250 may be a liquid crystal display (LCD), gas plasma, electronic ink, light emitting diode (LED), Organic LED (OLED) or any other type of light reflective or light transmissive display that can be used with a computer. In some embodiments, display 1250 may be a handheld projector or pico projector capable of projecting an image on a wall or other object.

Network computer 1200 may also comprise input/output interface 1238 for communicating with external devices or computers not shown in FIG. 12. Input/output interface 1238 can utilize one or more wired or wireless communication technologies, such as USB™, Firewire™, WiFi, WiMax, Thunderbolt™, Infrared, Bluetooth™, Zigbee™, serial port, parallel port, and the like.

Also, input/output interface 1238 may also include one or more sensors for determining geolocation information (e.g., GPS), monitoring electrical power conditions (e.g., voltage sensors, current sensors, frequency sensors, and so on), monitoring weather (e.g., thermostats, barometers, anemometers, humidity detectors, precipitation scales, or the like), or the like. Sensors may be one or more hardware sensors that collect or measure data that is external to network computer 1200. Human interface components can be physically separate from network computer 1200, allowing for remote input or output to network computer 1200. For example, information routed as described here through human interface components such as display 1250 or keyboard 1252 can instead be routed through the network interface 1232 to appropriate human interface components located elsewhere on the network. Human interface components include any component that allows the computer to take input from, or send output to, a human user of a computer. Accordingly, pointing devices such as mice, styluses, track balls, or the like, may communicate through pointing device interface 1258 to receive user input.

GPS transceiver 1240 can determine the physical coordinates of network computer 1200 on the surface of the Earth, which typically outputs a location as latitude and longitude values. GPS transceiver 1240 can also employ other geo-positioning mechanisms, including, but not limited to, triangulation, assisted GPS (AGPS), Enhanced Observed Time Difference (E-OTD), Cell Identifier (CI), Service Area Identifier (SAI), Enhanced Timing Advance (ETA), Base Station Subsystem (BSS), or the like, to further determine the physical location of network computer 1200 on the surface of the Earth. It is understood that under different conditions, GPS transceiver 1240 can determine a physical location for network computer 1200. In one or more embodiments, however, network computer 1200 may, through other components, provide other information that may be employed to determine a physical location of the client computer, including for example, a Media Access Control (MAC) address, IP address, and the like.

In at least one of the various embodiments, applications, such as, operating system 1206, visualization engine 1222, other applications 1229, or the like, may be arranged to employ geo-location information to select one or more localization features, such as, time zones, languages, currencies, currency formatting, calendar formatting, or the like. Localization features may be used in user interfaces, dashboards, visualizations, reports, as well as internal processes or databases. In at least one of the various embodiments, geo-location information used for selecting localization information may be provided by GPS 1240. Also, in some embodiments, geolocation information may include information provided using one or more geolocation protocols over the networks, such as, wireless network 1308 or network 1310.

Memory 1204 may include Random Access Memory (RAM), Read-Only Memory (ROM), or other types of memory. Memory 1204 illustrates an example of computer-readable storage media (devices) for storage of information such as computer-readable instructions, data structures, program modules or other data. Memory 1204 stores a basic input/output system (BIOS) 1208 for controlling low-level operation of network computer 1200. The memory also stores an operating system 1206 for controlling the operation of network computer 1200. It will be appreciated that this component may include a general-purpose operating system such as a version of UNIX, or Linux®, or a specialized operating system such as Microsoft Corporation's Windows® operating system, or the Apple Corporation's macOS® operating system. The operating system may include, or interface with one or more virtual machine modules, such as, a Java virtual machine module that enables control of hardware components or operating system operations via Java application programs. Likewise, other runtime environments may be included.

Memory 1204 may further include one or more data storage 1210, which can be utilized by network computer 1200 to store, among other things, applications 1220 or other data. For example, data storage 1210 may also be employed to store information that describes various capabilities of network computer 1200. The information may then be provided to another device or computer based on any of a variety of methods, including being sent as part of a header during a communication, sent upon request, or the like. Data storage 1210 may also be employed to store social networking information including address books, buddy lists, aliases, user profile information, or the like. Data storage 1210 may further include program code, data, algorithms, and the like, for use by a processor, such as processor 1202 to execute and perform actions such as those actions described below. In one embodiment, at least some of data storage 1210 might also be stored on another component of network computer 1200, including, but not limited to, non-transitory media inside processor-readable removable storage device 1236, processor-readable stationary storage device 1234, or any other computer-readable storage device within network computer 1200, or even external to network computer 1200. Data storage 1210 may include, for example, data sources 1214, dashboard models 1216, clipboard data 1218, or the like.

Applications 1220 may include computer executable instructions which, when executed by network computer 1200, transmit, receive, or otherwise process messages (e.g., SMS, Multimedia Messaging Service (MMS), Instant Message (IM), email, or other messages), audio, video, and enable telecommunication with another user of another mobile computer. Other examples of application programs include calendars, search programs, email client applications, IM applications, SMS applications, Voice Over Internet Protocol (VOIP) applications, contact managers, task managers, transcoders, database programs, word processing programs, security applications, spreadsheet programs, games, search programs, and so forth. Applications 1220 may include visualization engine 1222, other applications 1229, or the like, that may be arranged to perform actions for embodiments described below. In one or more of the various embodiments, one or more of the applications may be implemented as modules or components of another application. Further, in one or more of the various embodiments, applications may be implemented as operating system extensions, modules, plugins, or the like.

Furthermore, in one or more of the various embodiments, visualization engine 1222 other applications 1229, or the like, may be operative in a cloud-based computing environment. In one or more of the various embodiments, these applications, and others, that comprise the management platform may be executing within virtual machines or virtual servers that may be managed in a cloud-based based computing environment. In one or more of the various embodiments, in this context the applications may flow from one physical network computer within the cloud-based environment to another depending on performance and scaling considerations automatically managed by the cloud computing environment. Likewise, in one or more of the various embodiments, virtual machines or virtual servers dedicated to visualization engine 1222, or the like, may be provisioned and de-commissioned automatically.

Also, in one or more of the various embodiments, visualization engine 1222, other applications 1229, or the like, may be located in virtual servers running in a cloud-based computing environment rather than being tied to one or more specific physical network computers.

Further, network computer 1200 may also comprise hardware security module (HSM) 1260 for providing additional tamper resistant safeguards for generating, storing, or using security/cryptographic information such as, keys, digital certificates, passwords, passphrases, two-factor authentication information, or the like. In some embodiments, hardware security module may be employed to support one or more standard public key infrastructures (PKI), and may be employed to generate, manage, or store keys pairs, or the like. In some embodiments, HSM 1260 may be a stand-alone network computer, in other cases, HSM 1260 may be arranged as a hardware card that may be installed in a network computer.

Additionally, in one or more embodiments (not shown in the figures), network computer 1200 may include an embedded logic hardware device instead of a CPU, such as, an Application Specific Integrated Circuit (ASIC), Field Programmable Gate Array (FPGA), Programmable Array Logic (PAL), or the like, or combination thereof. The embedded logic hardware device may directly execute its embedded logic to perform actions. Also, in one or more embodiments (not shown in the figures), the network computer may include one or more hardware microcontrollers instead of a CPU. In one or more embodiments, the one or more microcontrollers may directly execute their own embedded logic to perform actions and access their own internal memory and their own external Input and Output Interfaces (e.g., hardware pins or wireless transceivers) to perform actions, such as System On a Chip (SOC), or the like.

1. A method for managing user interfaces using one or more processors that execute instructions to perform actions, comprising:
providing a dashboard that includes a plurality of zones and a plurality of user interface objects displayed in the dashboard, wherein a first user interface object is associated with a first zone and a second user interface object is associated with a second zone;
receiving a first user input corresponding to selection of one or more zones included in the plurality of zones; and
in response to receiving a second user input:
determining one or more user interface objects associated with the one or more zones based on a dashboard model that corresponds to the dashboard; and
copying the one or more zones and the one or more user interfaces objects into a container that is stored in a system clipboard; and
in response to receiving a second user input corresponding to a paste command directed to a target dashboard, performing actions:
employing a system clipboard application programming interface (API) to retrieve the container for the one or more copied zones and the one or more copied user interface objects, wherein one or more fields or sections of the container are employed to validate the container;
extracting the one or more copied zones and the one or more copied user interface objects from the container that is validated;
generating one or more new zones and one or more new user interface objects for a target dashboard model that is associated with the target dashboard based on the one or more copied zones and the one or more copied user interface objects that were extracted from the validated container;
integrating the one or more new zones and the one or more new user interface objects into the target dashboard model; and
displaying the one or more new zones and the one or more new user interface objects in the target dashboard based on the target dashboard model.

2. The method of claim 1, wherein generating the one or more new zones and the one or more new user interface objects, further comprises:
obtaining the container from the system clipboard;
traversing the contents of the container based on another dashboard model that is included in the container and independent of the dashboard;
determining one or more object types associated with the one or more new user interface objects based on the traversal; and
determining one or more attributes of the one or more new user interface objects based on the traversal.

3. The method of claim 1, wherein generating the one or more new zones and the one or more new user interface objects, further comprises:
determining extra data associated with a portion of the one or more copied user interface objects, wherein the extra data is one or more of image data, text data, or audio data;
obtaining the extra data from the container; and
including the extra data in the target dashboard model.

4. The method of claim 1, wherein integrating the one or more new zones and the one or more new user interface objects, further comprises:
determining one or more object identifiers associated with the one or more copied zones and the one or more copied user interface objects;
determining one or more other object identifiers associated with the target dashboard;
modifying the one or more object identifiers and the one or more other object identifiers, wherein the one or more modified object identifiers and the one or more modified other object identifiers conform to a policy associated with the target dashboard.

5. The method of claim 1, wherein generating the one or more new zones and the one or more new user interface objects, further comprises:
determining a version indicator associated with the one or more copied zones and the one or more copied user interface objects;
determining another version indicator associated with the target dashboard; and
in response to a mismatch of the version indicator and the other version indicator:
determining one or more characteristics of the one or more copied zones and the one or more copied user interface objects that correspond to the mismatch; and
modifying the one or more characteristics to conform with the other version indicator, wherein the one or more modified characteristics are included in the one or more new zones and the one or more new user interface objects.

6. The method of claim 1, wherein integrating the one or more new zones and the one or more new user interface objects, further comprises:
determining one or more actions associated with the one or more copied user interface objects based on its object type;
determining one or more other user interface objects in the target dashboard that are associated with the one or more actions; and
assigning the one or more actions to the one or more other user interface objects.

7. The method of claim 1, wherein the first user input or the second user input, further comprise, one or more of a pointing device action, a menu selection, or a keystroke.

8. A system for managing user interfaces, comprising:
a network computer, comprising:
a memory that stores at least instructions; and
one or more processors that execute instructions that perform actions, including:
providing a dashboard that includes a plurality of zones and a plurality of user interface objects displayed in the dashboard, wherein a first user interface object is associated with a first zone and a second user interface object is associated with a second zone;
receiving a first user input corresponding to selection of one or more zones included in the plurality of zones; and
in response to receiving a second user input:
determining one or more user interface objects associated with the one or more zones based on a dashboard model that corresponds to the dashboard; and
copying the one or more zones and the one or more user interfaces objects into a container that is stored in a system clipboard; and
in response to receiving a second user input corresponding to a paste command directed to a target dashboard, performing actions:
employing a system clipboard application programming interface (API) to retrieve the container for the one or more copied zones and the one or more copied user interface objects, wherein one or more fields or sections of the container are employed to validate the container;
extracting the one or more copied zones and the one or more copied user interface objects from the container that is validated;
generating one or more new zones and one or more new user interface objects for a target dashboard model that is associated with the target dashboard based on the one or more copied zones and the one or more copied user interface objects that were extracted from the validated container;
integrating the one or more new zones and the one or more new user interface objects into the target dashboard model; and
displaying the one or more new zones and the one or more new user interface objects in the target dashboard based on the target dashboard model; and
a client computer, comprising:
a memory that stores at least instructions; and
one or more processors that execute instructions that perform actions, including:
displaying one or more of the dashboard or the target dashboard on a hardware display.

9. The system of claim 8, wherein generating the one or more new zones and the one or more new user interface objects, further comprises:
obtaining the container from the system clipboard;
traversing the contents of the container based on another dashboard model that is included in the container and independent of the dashboard;
determining one or more object types associated with the one or more new user interface objects based on the traversal; and
determining one or more attributes of the one or more new user interface objects based on the traversal.

10. The system of claim 8, wherein generating the one or more new zones and the one or more new user interface objects, further comprises:
determining extra data associated with a portion of the one or more copied user interface objects, wherein the extra data is one or more of image data, text data, or audio data;
obtaining the extra data from the container; and
including the extra data in the target dashboard model.

11. The system of claim 8, wherein integrating the one or more new zones and the one or more new user interface objects, further comprises:
determining one or more object identifiers associated with the one or more copied zones and the one or more copied user interface objects;
determining one or more other object identifiers associated with the target dashboard;
modifying the one or more object identifiers and the one or more other object identifiers, wherein the one or more modified object identifiers and the one or more modified other object identifiers conform to a policy associated with the target dashboard.

12. The system of claim 8, wherein generating the one or more new zones and the one or more new user interface objects, further comprises:
determining a version indicator associated with the one or more copied zones and the one or more copied user interface objects;
determining another version indicator associated with the target dashboard; and
in response to a mismatch of the version indicator and the other version indicator:
determining one or more characteristics of the one or more copied zones and the one or more copied user interface objects that correspond to the mismatch; and
modifying the one or more characteristics to conform with the other version indicator, wherein the one or more modified characteristics are included in the one or more new zones and the one or more new user interface objects.

13. The system of claim 8, wherein integrating the one or more new zones and the one or more new user interface objects, further comprises:
determining one or more actions associated with the one or more copied user interface objects based on its object type;
determining one or more other user interface objects in the target dashboard that are associated with the one or more actions; and
assigning the one or more actions to the one or more other user interface objects.

14. The system of claim 8, wherein the first user input or the second user input, further comprise, one or more of a pointing device action, a menu selection, or a keystroke.

15. A processor readable non-transitory storage media that includes instructions for managing user interfaces, wherein execution of the instructions by one or more processors, performs actions, comprising:
providing a dashboard that includes a plurality of zones and a plurality of user interface objects displayed in the dashboard, wherein a first user interface object is associated with a first zone and a second user interface object is associated with a second zone;
receiving a first user input corresponding to selection of one or more zones included in the plurality of zones; and
in response to receiving a second user input:
determining one or more user interface objects associated with the one or more zones based on a dashboard model that corresponds to the dashboard; and
copying the one or more zones and the one or more user interfaces objects into a container that is stored in a system clipboard; and
in response to receiving a second user input corresponding to a paste command directed to a target dashboard, performing actions:
employing a system clipboard application programming interface (API) to retrieve the container for the one or more copied zones and the one or more copied user interface objects, wherein one or more fields or sections of the container are employed to validate the container;
extracting the one or more copied zones and the one or more copied user interface objects from the container that is validated;
generating one or more new zones and one or more new user interface objects for a target dashboard model that is associated with the target dashboard based on the one or more copied zones and the one or more copied user interface objects that were extracted from the validated container;
integrating the one or more new zones and the one or more new user interface objects into the target dashboard model; and
displaying the one or more new zones and the one or more new user interface objects in the target dashboard based on the target dashboard model.

16. The media of claim 15, wherein generating the one or more new zones and the one or more new user interface objects, further comprises:
obtaining the container from the system clipboard;
traversing the contents of the container based on another dashboard model that is included in the container and independent of the dashboard;
determining one or more object types associated with the one or more new user interface objects based on the traversal; and
determining one or more attributes of the one or more new user interface objects based on the traversal.

17. The media of claim 15, wherein generating the one or more new zones and the one or more new user interface objects, further comprises:
determining extra data associated with a portion of the one or more copied user interface objects, wherein the extra data is one or more of image data, text data, or audio data;
obtaining the extra data from the container; and
including the extra data in the target dashboard model.

18. The media of claim 15, wherein integrating the one or more new zones and the one or more new user interface objects, further comprises:
determining one or more object identifiers associated with the one or more copied zones and the one or more copied user interface objects;
determining one or more other object identifiers associated with the target dashboard;
modifying the one or more object identifiers and the one or more other object identifiers, wherein the one or more modified object identifiers and the one or more modified other object identifiers conform to a policy associated with the target dashboard.

19. The media of claim 15, wherein generating the one or more new zones and the one or more new user interface objects, further comprises:
determining a version indicator associated with the one or more copied zones and the one or more copied user interface objects;
determining another version indicator associated with the target dashboard; and
in response to a mismatch of the version indicator and the other version indicator:
determining one or more characteristics of the one or more copied zones and the one or more copied user interface objects that correspond to the mismatch; and
modifying the one or more characteristics to conform with the other version indicator, wherein the one or more modified characteristics are included in the one or more new zones and the one or more new user interface objects.

20. The media of claim 15, wherein integrating the one or more new zones and the one or more new user interface objects, further comprises:
determining one or more actions associated with the one or more copied user interface objects based on its object type;
determining one or more other user interface objects in the target dashboard that are associated with the one or more actions; and
assigning the one or more actions to the one or more other user interface objects.
